(19) United States
(12) Patent Application Publication
(10) Pub. No.: US 2006/0181867 A1
(43) Pub. Date: Aug. 17, 2006

(54) Light-diffusing member, backlight assembly having the light-diffusing member and display apparatus having the backlight assembly

(75) Inventors: Seong-Sik Choi, Seoul (KR); Dong-Lyoul Shin, Suwon-si (KR); Doo-Won Lee, Seoul (KR); Kui-Yong Choi, Suwon-si (KR); Ju-Hwa Ha, Seoul (KR); Byung-Yun Joo, Goyang-si (KR); Jung-Wook Paek, Suwon-si (KR); Jin-Sung Choi, Cheonan-si (KR); Heu-Gon Kim, Suwon-si (KR); Sang-Hoon Lee, Yongin-si (KR); Jae-Hwan Chun, Suwon-si (KR)

Correspondence Address: MCGUIREWOODS, LLP, 1750 TYSONS BLVD, SUITE 1800, MCLEAN, VA, 22102, US

(73) Assignee: Samsung Electronics Co., Ltd.

(21) Appl. No.: 11/300,413

(22) Filed: Dec. 15, 2005

(30) Foreign Application Priority Data
Dec. 16, 2004 (KR) 2004-106760
Jan. 20, 2005 (KR) 2005-005261
Feb. 5, 2005 (KR) 2005-10930

(51) Int. Cl. G09F 13/04

(52) U.S. Cl. 362/97; 362/30; 362/246

(57) ABSTRACT

A light-diffusing member includes a first face, a second face arranged opposite to the first face, and a light-diffusing portion including at least one valley and at least one ridge that are alternatively arranged. A first thickness of the light-diffusing member between the ridge and the first face is about 1.15 to about 1.80 times greater than a second thickness of the light-diffusing member between the valley and the first face.

### CROSS REFERENCE TO RELATED APPLICATION

This application claims priority under 35 USC §119 to Korean Patent Application Nos. 10-2004-0106760, filed on Dec. 16, 2004, 10-2005-0005261, filed on Jan. 13, 2005, and 10-2005-0109300, filed on Feb. 5, 2005, the contents of which are herein incorporated by reference in its entirety for all purposes.

### BACKGROUND OF THE INVENTION

1. Field of the Invention

The present invention relates to a light-diffusing member, a backlight assembly having the light-diffusing member and a liquid crystal display (LCD) apparatus having the backlight assembly. Specifically, the present invention relates to a light-diffusing member that is capable of improving luminance and luminance uniformity of a light, a backlight assembly having the light-diffusing member, and an LCD apparatus having the backlight assembly.

2. Description of the Related Art

A display device displays an image in accordance with data processed by an information-processing device. An LCD device is a type of a display device that includes a liquid crystal (LC) layer, an LC-controlling part that controls the LC layer, and a light-providing part that provides a light to the LC layer.

The LC layer has electrical characteristics, such as arrangements of LC molecules that are changed by an electric field, and optical characteristics, such as light transmissivity that is changed in accordance with the arrangements of the LC molecules.

The light-controlling part includes a pair of substrates, and electrodes are provided to each of the substrates. The LC layer is arranged between the substrates. The electric field is applied to the LC layer to change the arrangements of the LC molecules in the LC layer.

The light-providing part provides the light to the LC layer. The light-providing part includes a light source, e.g., a lamp emitting the light, and a light-diffusing member improving luminance and luminance uniformity of the light. The lamp may be a cold cathode fluorescent lamp (CCFL) having a tubular like shape. The light-diffusing member includes a diffusion plate that improves the luminance of the light by removing bright lines generated by the CCFL.

However, a problem arises because the conventional diffusion plate does not completely remove the bright lines, which negatively affects display quality.

### SUMMARY OF THE INVENTION

The present invention provides a light-diffusing member that is capable of improving luminance of a light by removing bright lines generated by a light source.

Additional features of the invention will be set forth in the description which follows, and in part will be apparent from the description, or may be learned by practice of the invention.

The present invention discloses light-diffusing member, including a first face; a second face arranged opposite to the first face; and a light-diffusing portion including a valley being alternatively arranged with a ridge, wherein a first thickness of the light-diffusing member between the ridge and the first face is about 1.15 to about 1.80 times greater than a second thickness of the light-diffusing member between the valley and the first face.

The present invention also discloses a backlight assembly, including a light source; a light-diffusing member diffusing a light emitted from the light source, the light-diffusing member including a face that faces the light source and has an indented structure extending along a lengthwise direction of the light source, and a substantially level portion; and a fixing member supporting the substantially level portion of the light-diffusing member with the light diffusing member.

The present invention also discloses a backlight assembly, including a light source generating a first light having a first luminance and a second light having a second luminance that is different from the first luminance; and a first optical member arranged over the light source to provide the first light and the second light with uniformity, the first optical member including a first portion having a first thickness and a second portion having a second thickness that is different from the first thickness.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a plan view showing a light-diffusing member according to an embodiment of the invention.

FIG. 2 is a cross sectional view taken along line I-I′ in FIG. 1;

FIG. 3 is a graph showing luminance distribution of the light-diffusing member shown in FIG. 1.

FIG. 4 is a graph showing luminance and luminance uniformity analyzed using statistical analysis.

FIG. 5 is a cross sectional view showing a light-diffusing member according to an embodiment of the invention.

FIG. 6 is a cross sectional view showing a light-diffusing member according to an embodiment of the invention.

FIG. 7 is a cross sectional view showing a light-diffusing member according to an embodiment of the invention.

FIG. 8 is a cross sectional view showing illustrating a backlight assembly according to an embodiment of the invention.

FIG. 9 is an exploded perspective view showing the backlight assembly shown in FIG. 8.

FIG. 10 is an enlarged perspective view showing a portion “A” shown in FIG. 9.

FIG. 11 is a cross sectional view showing a display apparatus according to an embodiment of the invention.

FIG. 12 is an exploded perspective view showing the display apparatus shown in FIG. 11.

FIG. 13 is an exploded perspective view showing a backlight assembly according to an embodiment of the invention.

FIG. 14 is a partially exploded perspective bottom view showing the backlight assembly shown in FIG. 13.

FIG. 15 is a perspective view showing the backlight assembly shown in FIG. 14.

FIG. 16 is a cross sectional view taken along line II-II′ shown in FIG. 15.

FIG. 17 is an exploded perspective view showing illustrating a backlight assembly according to an embodiment of the invention.

FIG. 18 is a perspective view showing the backlight assembly shown in FIG. 17.

FIG. 19 is an exploded perspective view showing a display apparatus having a backlight assembly according to an embodiment of the invention.

FIG. 20 is a perspective view showing a backlight assembly according to an embodiment of the invention.

FIG. 21 is a cross sectional view taken along line IV-IV′ shown in FIG. 20.

FIG. 22A, FIG. 22B, and FIG. 22C are graphs illustrating variations of luminance generated from a light source unit shown in FIG. 21.

FIG. 23 is a perspective view showing a display apparatus according to an embodiment of the invention.

### DESCRIPTION OF THE ILLUSTRATED EMBODIMENTS

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, the element or layer may be directly on, connected or coupled to the other element or layer or intervening elements or layers may be present. In contrast, when an element is referred to as being “directly on,” “directly connected to” or “directly coupled to” another element or layer, no intervening elements or layers are present. Like numbers refer to like elements throughout.

Spatially relative terms, such as “beneath”, “below”, “lower”, “above”, “upper” and the like, may be used herein for ease of description to describe one element or feature's relationship to another element(s) or feature(s) as illustrated in the figures. It is understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features

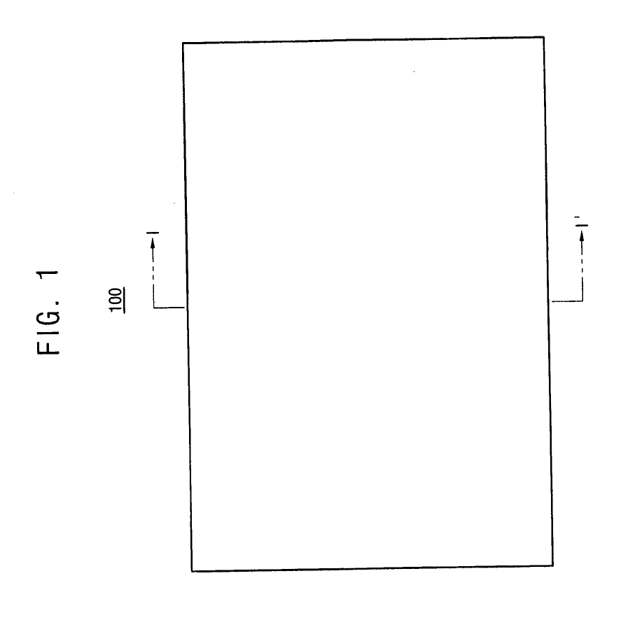

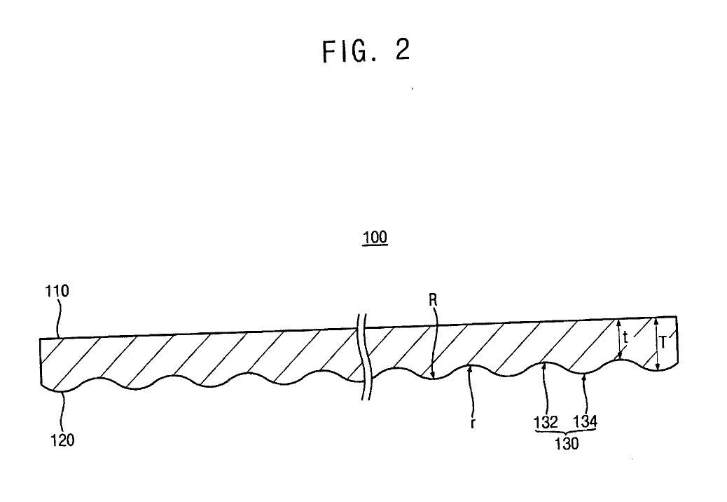

FIG. 1 is a plan view illustrating a light-diffusing member according to an embodiment of the invention. FIG. 2 is a cross sectional view taken along line I-I′ shown in FIG. 1.

Referring to FIG. 1 and FIG. 2, a light-diffusing member 100 includes a first face 110 and a second face 120 arranged opposite to the first face 110. The light-diffusing member 110 may have a rectangular like plate shape. The light-diffusing member 100 may include polymethaacrylacrylate (PMMA). The light-diffusing member 110 directs light rays incident upon the second face 120 to the first face 110. For example, light rays exiting the first face 110 may include diffused light rays.

The first face 110 has a substantially level surface. An optical structure 130 is provided on the second face 120. The optical structure 130 includes valleys 132 and ridges 134 alternately arranged and spaced apart from each other. Each of the valleys 132 has a curvature radius r of about 0.5 mm to about 1 mm.

The ridges 134 are positioned between valleys 132 and form a wave-like structure with the valleys 132. Each of the ridges 134 has a curvature radius R of about 0.5 mm to about 1 mm. A plan view of the ridges 134 is a semi-cylindrical like shape.

The light-diffusing member 100 has a first thickness T between the first face 110 and a top surface of the ridges 134 and a second thickness t between the first face 110 and a bottom depth of the valleys 132. To improve luminance and luminance uniformity of the light rays, the first and second thicknesses T and t are appropriately adjusted. The second thickness t may be about 1.5 mm to about 2.0 mm.

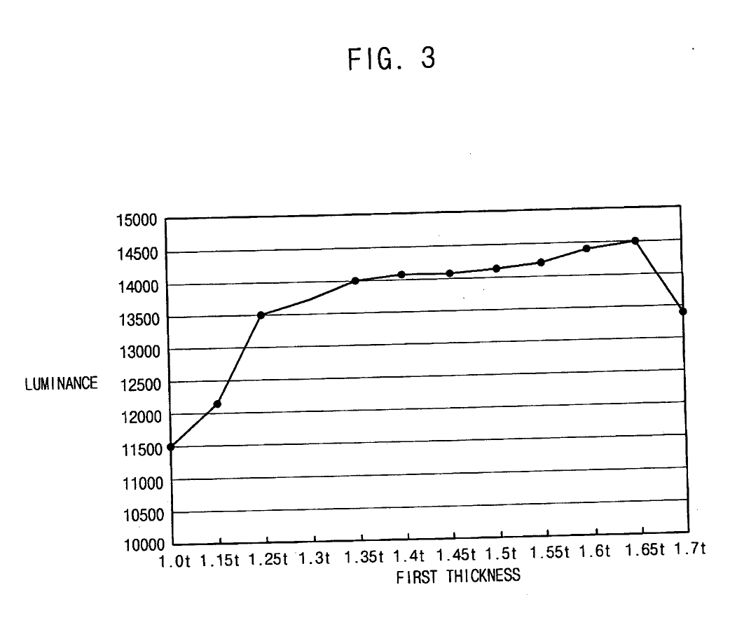

FIG. 3 is a graph showing luminance distribution of the light-diffusing member shown in FIG. 1. The X-axis indicates a first thickness T of the light-diffusing members and the Y-axis indicates luminance of light rays exiting from the first face of the light-diffusing member.

To measure luminance variations according to differences between the first thickness T and the second thickness t, a plurality of the light-diffusing members 100 were prepared. Each of the light-diffusing members 100 has a different first thickness T from each other and a different second thickness t from each other. The first thickness T is about 1.0 to about 1.80 times greater than the second thickness t.

To measure the luminance of light rays exiting from the first faces 110 of each of the light-diffusing members 100, the light-diffusing members 100 were formed using PMMA. The valleys 132 and the ridges 134 of each of the light-diffusing members 100 have a curvature radius of about 0.5 mm and about 1 mm, respectively. A plurality of lamps providing the light rays to the light-diffusing members 100 are positioned under each of the valleys 132. A distance between the light-diffusing members 100 and the lamps is about 11.8 mm and a distance between center points of adjacent lamps is about 20.0 mm. Further, the luminance of the light rays exiting from the first faces 110 of the light-diffusing members 100 corresponds to a mean value of luminance that is measured at nine points on the first face 110.

As shown in FIG. 3, when the first thickness T was about 1.15 to about 1.7 times greater than the second thickness t, the luminance of the light rays substantially increases.

Preparing Light Diffusing Members

### COMPARATIVE EXAMPLE

A light-diffusing member has a first thickness that is substantially the same as a second thickness.

### Example 1

A light-diffusing member has a first thickness that is about 1.15 times greater than a second thickness.

### Example 2

A light-diffusing member has a first thickness that is about 1.25 times greater than a second thickness.

### Example 3

A light-diffusing member has a first thickness that is about 1.30 times greater than a second thickness.

### Example 4

A light-diffusing member has a first thickness that is about 1.35 times greater than a second thickness.

### Example 5

A light-diffusing member has a first thickness that is about 1.40 times greater than a second thickness.

### Example 6

A light-diffusing member has a first thickness that is about 1.45 times greater than a second thickness.

### Example 7

A light-diffusing member has a first thickness that is about 1.50 times greater than a second thickness.

### Example 8

A light-diffusing member has a first thickness that is about 1.55 times greater than a second thickness.

### Example 9

A light-diffusing member has a first thickness that is about 1.60 times greater than a second thickness.

### Example 10

A light-diffusing member has a first thickness that is about 1.67 times greater than a second thickness.

### Example 11

A light-diffusing member has a first thickness that is about 1.75 times greater than a second thickness.

Measuring Luminance of Light Rays Exiting the Light-Diffusing Members

Luminance of the light rays exiting the first face of the Comparative Example and the first face of Examples 1 through 10 was measured. The measured luminances is shown below in Table 1.

TABLE 1

| | Magnifications of first thickness with respect | Lumincance |
|---|---|---|
| | to second thickness | (nit = cd/m²) |
| Comparative | 1.00 | 11,500 |
| Example | | |
| Example 1 | 1.15 | 12,140 |
| Example 2 | 1.25 | 13,476 |
| Example 3 | 1.30 | 13,720 |
| Example 4 | 1.35 | 13,980 |
| Example 5 | 1.40 | 14,050 |
| Example 6 | 1.45 | 14,080 |
| Example 7 | 1.50 | 14,130 |
| Example 8 | 1.55 | 14,220 |
| Example 9 | 1.60 | 14,440 |
| Example 10 | 1.67 | 14,500 |
| Example 11 | 1.75 | 13,400 |

As shown in Table 1, the light-diffusing member of the Comparative Example having the first thickness and second thickness substantially identical to each other emits a light ray having a luminance of about 11,500/nit.

In comparison, the light-diffusing member of Example 1 having the first thickness that is about 1.15 times greater than the second thickness emits a light ray having a luminance of about 12,140/nit, which is greater than the luminance of the light ray emitted from the light-diffusing member of the Comparative Example.

The light-diffusing member of Example 2 having the first thickness that is about 1.25 times greater than the second thickness emits a light ray having a luminance of about 13,476 nit, which is greater than the luminance of the light ray emitted from the light-diffusing member of the Comparative Example.

The light-diffusing member of Example 3 having the first thickness that is about 1.30 times greater than the second thickness emits a light ray having a luminance of about 13,720 nit, which is greater than the luminance of the light ray emitted from the light-diffusing member of the Comparative Example.

The light-diffusing member of Example 4 having the first thickness that is about 1.35 times greater than the second thickness emits a light ray having a luminance of about 13,980 nit, which is greater than the luminance of the light ray emitted from the light-diffusing member of the Comparative Example.

The light-diffusing member of Example 5 having the first thickness that is about 1.40 times greater than the second thickness emits a light ray having a luminance of about 14,050 nit, which is greater than the luminance of the light ray emitted from the light-diffusing member of the Comparative Example.

The light-diffusing member of Example 6 having the first thickness that is about 1.45 times greater than the second thickness emits a light ray having a luminance of about 14,080 nit, which is greater than the luminance of the light ray emitted from the light-diffusing member of the Comparative Example.

The light-diffusing member of Example 7 having the first thickness that is about 1.50 times greater than the second thickness emits a light ray having a luminance of about 14,130 nit, which is greater than the luminance of the light ray emitted from the light-diffusing member of the Comparative Example.

The light-diffusing member of Example 8 having the first thickness that is about 1.55 times greater than the second thickness emits a light ray having a luminance of about 14,220 nit, which is greater than the luminance of the light ray emitted from the light-diffusing member of the Comparative Example.

The light-diffusing member of Example 9 having the first thickness that is about 1.60 times greater than the second thickness emits a light ray having a luminance of about 14,400 nit, which is greater than the luminance of the light ray emitted from the light-diffusing member of the Comparative Example.

The light-diffusing member of Example 10 having the first thickness that is about 1.67 times greater than the second thickness emits a light ray having a luminance of about 14,500 nit, which is greater than the luminance of the light ray emitted from the light-diffusing member of the Comparative Example.

Thus, the light-diffusing members of Examples 1 through 10 emit light rays having a luminance that is substantially proportional to an increase of the first thickness.

However, the light-diffusing member of Example 11 having the first thickness that is about 1.75 times greater than the second thickness emits a light ray having a luminance of about 13,400 nit is lower than the luminance of the light ray emitted from the light-diffusing member of Example 10.

Thus, when the first thickness is more than about 1.70 times greater than the second thickness, the luminance gradually decreases. The above experiment shows that the light-diffusing member having the first thickness that is about 1.15 to about 1.80 times greater than the second thickness emits a light ray having a higher luminance than the light ray emitted from the light-diffusing member where the first thickness is substantially identical to the second thicknesses. In particular, the experiment shows that the light ray has the highest luminance when the first thickness of the light diffusing member is about 1.67 times greater than the second thickness.

Luminance and luminance uniformity of a light ray emitted from the light-diffusing member may be calculated using Equation 1 and Equation 2, discussed below. Parameters determining Equation 1 and Equation 2 include an interval D between lamps, a distance H between the lamps and the light-diffusing member, a curvature radius R of a ridge, a curvature radius r of a valley, a first thickness T of the light diffusing member between the ridge face, etc. The parameters are shown below in Table 2.

TABLE 2

| | | | | | | | Luminance |
|---|---|---|---|---|---|---|---|
| | D | H | R | r | T | Luminance | uniformity |
| No. | (mm) | (mm) | (mm) | (mm) | (mm) | (nit) | (%) |
| 1 | 20 | 11.8 | 0.5 | 0.5 | 2 | 14,200 | 77 |
| 2 | 30 | 11.8 | 0.5 | 0.5 | 1 | 13.200 | 69 |
| 3 | 20 | 17.6 | 0.5 | 0.5 | 1 | 13,420 | 78 |
| 4 | 30 | 17.6 | 0.5 | 0.5 | 2 | 12,800 | 76 |
| 5 | 20 | 11.8 | 1.0 | 0.5 | 1 | 12,980 | 87 |
| 6 | 30 | 11.8 | 1.0 | 0.5 | 2 | 13,200 | 92 |
| 7 | 20 | 17.6 | 1.0 | 0.5 | 2 | 12,600 | 90 |
| 8 | 30 | 17.6 | 1.0 | 0.5 | 1 | 12,900 | 85 |
| 9 | 20 | 11.8 | 0.5 | 1.0 | 1 | 13,600 | 88 |
| 10 | 30 | 11.8 | 0.5 | 1.0 | 2 | 13,100 | 81 |
| 11 | 20 | 17.6 | 0.5 | 1.0 | 2 | 13,000 | 86 |
| 12 | 30 | 17.6 | 0.5 | 1.0 | 1 | 13,300 | 84 |
| 13 | 20 | 11.8 | 1.0 | 1.0 | 2 | 13,350 | 81 |
| 14 | 30 | 11.8 | 1.0 | 1.0 | 1 | 13,450 | 72 |
| 15 | 20 | 17.6 | 1.0 | 1.0 | 1 | 12,700 | 77 |
| 16 | 30 | 17.6 | 1.0 | 1.0 | 2 | 12,300 | 79 |

The parameters in Table 2 are analyzed using a statistical analysis program to predict the luminance of the light rays emitted from the light-diffusing members. For example, Minitab™ of Minitab, inc. in USA may be used as software for the statistical analysis program. The predicted luminance of the light rays is at least about 95% accurate.

A total coefficient, a coefficient of the interval D, a coefficient of the distance H, coefficients of the curvature radii R and r, and a coefficient of the thickness T are obtained using the statistical analysis program. An obtained total coefficient is about 15,787.5, an obtained coefficient of the interval D is about −20.0, an obtained coefficient of the distance H is about −87.5, an obtained coefficient of the curvature radius R is about −785.0, an obtained coefficient of the curvature radius r is about −125.0, and an obtained coefficient of the thickness T is about −125. Thus, Equation 1 is represented as shown below.
Luminance (nit)=15787.5−20D−87.5H−785R−125r−125T Equation 1

The luminance of the light ray emitted from the first face of the light-diffusing member that is at least about 95% accurate is calculated using Equation 1.

As discussed above, the parameters in Table 2 are analyzed using a statistical analysis program.

A total coefficient, a coefficient of the interval D, a coefficient of the distance H, coefficients of the curvature radii R and r, and a coefficient of the thickness T may be obtained using the statistical analysis program. An obtained total coefficient is about 43.47, an obtained coefficient of the interval D is about −0.325, an obtained coefficient of the distance H is about 0.172, an obtained coefficient of the curvature radius R is about 54, an obtained coefficient of the curvature radius r is about 61.5, and an obtained coefficient of the thickness T is about −4.75. Thus, Equation 2 is represented as follows.
Luminance uniformity (%)=43.47−0.325D+0.172H+54R+61.5r−4.75T Equation 2

The luminance uniformity of the light ray emitted from the first face of the light-diffusing member having an accuracy that is greater than or equal to about 95% is calculated using Equation 2.

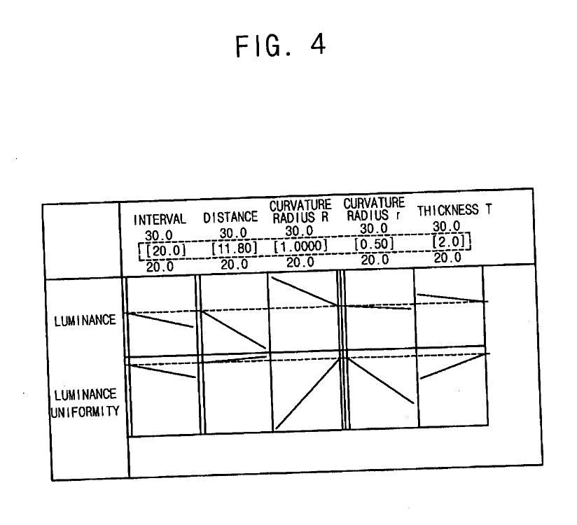

FIG. 4 is a graph illustrating luminance and luminance uniformity that are analyzed using a statistical analysis program.

Referring to Table 2 and FIG. 4, the luminance and luminance uniformity improve when the interval between the lamps is about 20 mm, the distance between the light-diffusing member and the center point of the each of the lamps is about 11.8 mm, the curvature radius of the ridge is about 1.0 mm, the curvature radius of the valley is about 0.5 mm, and the first thickness of the light-diffusing member between the ridge and the first face is about 2.0 mm, the luminance is about 13,260 nit and the luminance uniformity is about 92.25%.

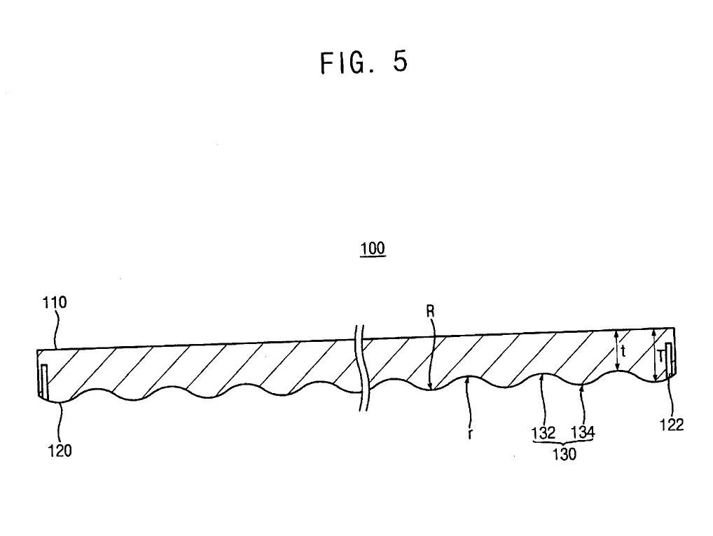

FIG. 5 is a cross sectional view illustrating a light-diffusing member according to an embodiment of the invention.

A light-diffusing member includes elements that are substantially identical to those of the light-diffusing member in FIG. 2, except for a fixing slot. Thus, same reference numerals refer to same elements and any further illustrations with respect to the elements are omitted for purposes of necessity.

Referring to FIG. 5, attaching the light-diffusion member 100 to a desired position may be difficult because the optical structure 130 includes the alternatively arranged ridges 134 and the valleys 132.

At least one fixing slot 122 may be formed at a surface portion of the second face 120 so that the light diffusion member 100 may be attached to the desired position. The fixing protrusion (not shown) of a member (not shown) facing the light-diffusing member 100 may be inserted into the fixing slot 122 so that the light-diffusing member 100 may be secured to the desired position of the member.

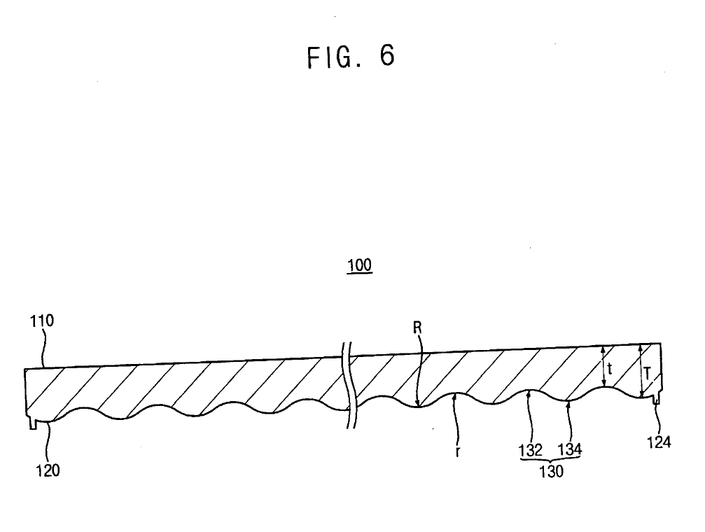

FIG. 6 is a cross sectional view illustrating a light-diffusing member according to an embodiment of the invention.

A light-diffusing member includes elements substantially identical to those of the light-diffusing member in FIG. 2, except for a fixing protrusion. Thus, same reference numerals refer to same elements and any further illustrations with respect to the elements are omitted for purposes of convenience.

Referring to FIG. 6, attaching the light-diffusion member 100 to a desired position may be difficult because the optical structure 130 includes the alternatively arranged ridges 134 and the valleys 132.

At least one fixing protrusion 124 protrudes from the second face 120 so that the light diffusion member 100 may be attached to the light diffusion member. The fixing protrusion 124 may be inserted into a fixing slot (not shown) of a member facing the light-diffusing member 100 so that the light-diffusing member 100 may be secured to the desired position of the member.

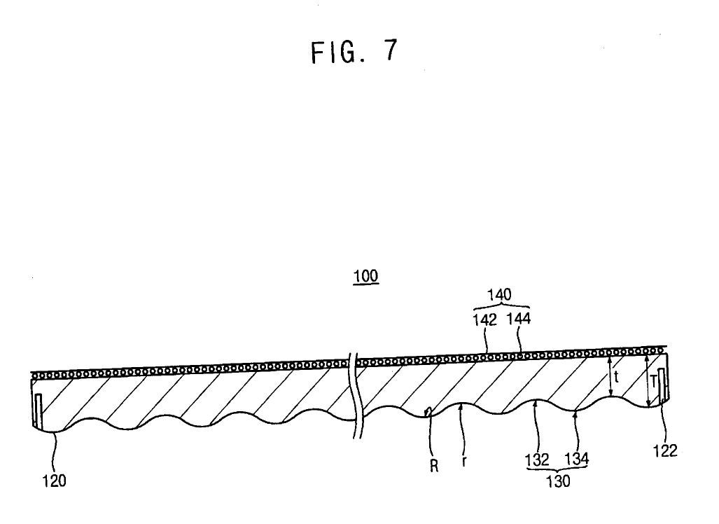

FIG. 7 is a cross sectional view illustrating a light-diffusing member according to an embodiment of the invention.

A light-diffusing member includes elements that are substantially identical to those of the light-diffusing member in FIG. 2 except for a fixing protrusion. Thus, same reference numerals refer to same elements and any further illustrations with respect to the elements are omitted for purposes of convenience.

Referring to FIG. 7, the light-diffusing member 100 further includes a light-diffusing layer 140 formed on the first face 110. The light-diffusing layer 140 includes a binder 142 having a first reflexibility and light-diffusing beads 144 in the binder 142. The light-diffusing beads 144 have a second reflexibility that is different from the first reflexibility.

The binder 142 secures the light-diffusing beads 144 with the first face 110. The light-diffusing beads 144 may have a spherical like shape. The light-diffusing beads 144 may be formed of polyethylene terephthalate (PET).

The light-diffusing layer 140 including the binder 142 and the light-diffusing beads 144 diffuses again the light rays passing through the first face 110 of the light-diffusing member 100 to improve the luminance and the luminance uniformity of the light rays.

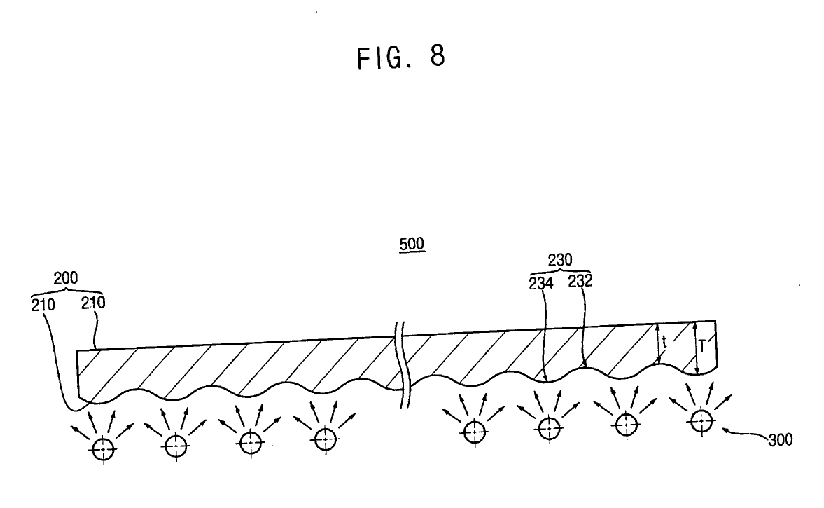

FIG. 8 is a cross sectional view illustrating a backlight assembly according to an embodiment of the invention.

Referring to FIG. 8, a backlight assembly 500 includes a light-diffusing member 200 and a light source 300 providing light rays to the light-diffusing member 200.

The light-diffusing member 200 faces the light source 300 and diffuses the light rays emitted from the light source 300. The light-diffusing member 200 includes a first face 210 through which the light rays exit and a second face 220 opposite to the first face 210. The first face 210 has a substantially level surface. The second face 220 includes an optical structure 230 formed thereon. The optical structure 230 has a wave-like structure including valleys 232 and ridges 234 alternatively arranged. Each of the valleys 232 has a curvature radius r of about 0.5 mm to about 1 mm. Each of the ridges 234 has a curvature radius R of about 0.5 mm to about 1 mm. A plan view of the ridges 134 is a semi-cylindrical like shape.

The light-diffusing member 200 has a first thickness T between the first face 210 and the ridges 234 and a second thickness t between the first face 210 and the valleys 232. To improve luminance and luminance uniformity of the light rays, the first and second thickness T and t are adjusted appropriately.

To improve luminance and luminance uniformity of the light rays emitted from the light source 300, the first thickness T may be about 1.15 to about 1.80 times thicker than the 20 second thickness t. In particular, the first thickness T may be about 1.15 to about 1.35 times, about 1.35 to about 1.55 times thicker than the second thickness, about 1.55 to about 1.67 times thicker than the second thickness or about 1.67 to about 1.75 times thicker than the second thickness t. Preferably, the first thickness T is about 1.67 times thicker than the second thickness t.

The light source 300 may have a cylindrical like shape, a U like shape, a C like shape, etc. The light source 300 may correspond to an internal CCFL or an external CCFL.

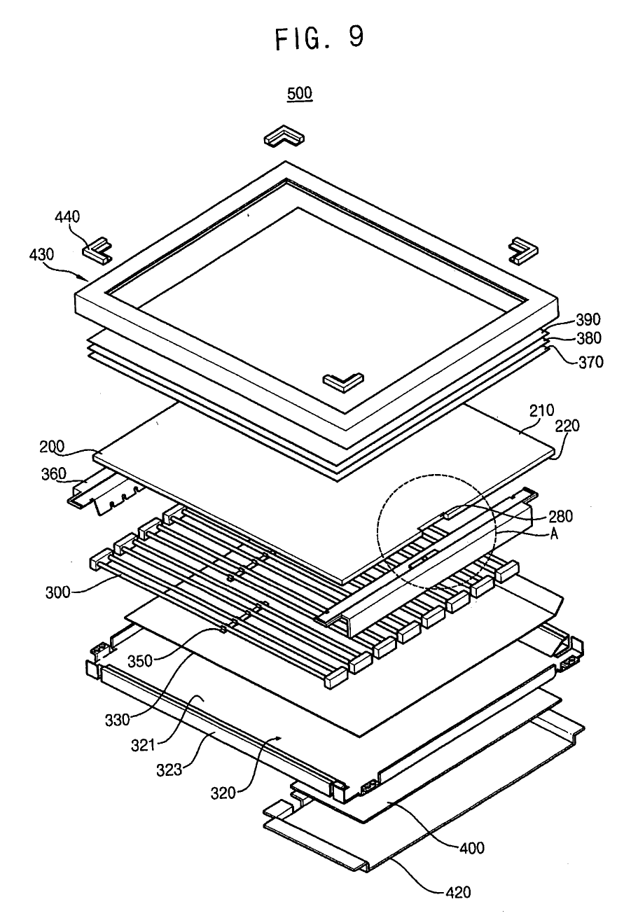

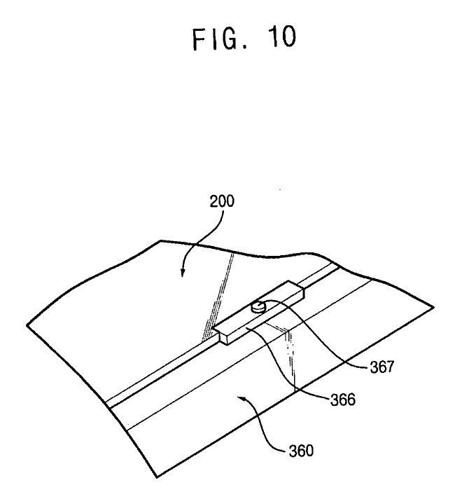

FIG. 9 is an exploded perspective view showing the backlight assembly shown in FIG. 8. FIG. 10 is an enlarged perspective view showing a portion “A” shown in FIG. 9.

Referring to FIG. 9 and FIG. 10, the backlight assembly 500 further includes a container 320 in which the light-diffusing member 200 and the light source 300 are received.

The container 320 has a bottom face 321 and a sidewall 323 extending from an edge portion of the bottom face 321. The bottom face 321 and the sidewall 323 together define a receiving space where the light-diffusing member 200 and the light source 300 are received.

The backlight assembly 500 may further include an inverter 400 that provides a driving power for transmitting the light rays from the light source 300, to the light source 300. The inverter 400 may be arranged under the bottom face 321 of the container 320.

A shield case 420 is arranged with the bottom face 321 of the container 320 to cover the inverter 400. The shield case 420 removes harmful electromagnetic waves that are generated by the inverter 400.

A reflection plate 330 is arranged between the bottom face 321 of the container 320 and the light source 300. The reflection plate 330 may be arranged below the bottom face 321 of the container 320. The reflection plate 330 reflects light rays to the light-diffusing member 200, which increases an amount of light incident upon the second face 220 of the light-diffusing member 200.

A light source support 350 attaches the light source 300 with the container 320. For example, the light source support 350 to which the light source 300 is secured or attached to the container 300.

A fixing frame 360 covers opposite ends of the light source 300 and is attached with the light-diffusing member 200. To prevent or significantly reduce movement of the light-diffusing member 200 from container 320, the light-diffusing member 200 may include a fixing slot 280 and the fixing frame 360 has a fixing protrusion 366 tightly inserted into the fixing slot 280. Alternatively, the fixing protrusion 366 may extend from the light-diffusing member 200 and fixing frame 360 may include the fixing slot 280.

An optical member may be arranged on the light-diffusing member 200. A fixing boss 367 may be formed on the fixing protrusion 366. The fixing boss 367 may be inserted into the optical member so that the optical member is sufficiently secured to the fixing frame 360.

The optical member may include a diffusion sheet 370 arranged on the light-diffusing member 200. The diffusion sheet 370 diffuses again light rays passing through the first face 210 of the light-diffusing member 200. A prism sheet 380 may be arranged on the diffusion sheet 370. The prism sheet 380 increases front luminance of light rays passing through the diffusion sheet 370. Additionally, a reflective polarizing sheet 390 may be arranged on the prism sheet 380. The reflective polarizing sheet 390 improves light rays passing through the prism sheet 380.

The backlight assembly 500 may also include a middle mold frame 430 that is combined with the container 320 to prevent or significantly reduce movement of the light-diffusion member 200. The number of middle mold frames 430 may vary in accordance with a size of a display apparatus. For example, the middle mold frame 430 may include at least two frames.

Panel-guiding members 440 may be arranged at edge portions of the middle mold frame 430 to guide positions of the edges of an LCD panel. The panel-guiding members 440 may have an L like shape and may be formed with an elastic material.

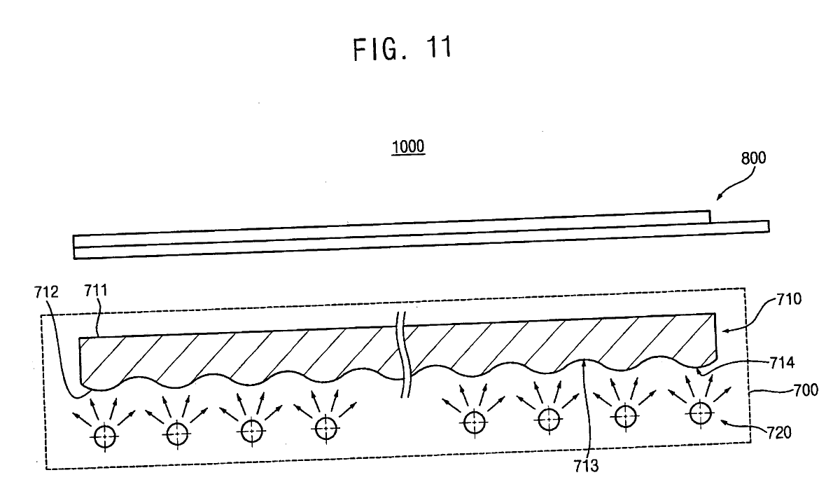

FIG. 11 is a cross sectional view illustrating a display apparatus according to an embodiment of the invention.

Referring to FIG. 11, a display apparatus 1000 includes a backlight assembly 700 and a display panel 800.

The backlight assembly 700 includes a light-diffusing member 710 and a light source 720 providing light rays to the light-diffusing member 710.

The light-diffusing member 710 faces the light source 720 and diffuses the light rays emitted from the light source 720. The light-diffusing member 710 includes a first face 711 through which the light rays exit and a second face 712 to which the light rays are irradiated. The second face 712 is arranged opposite to the first face 711.

The first face 711 has a substantially level surface. The second face 712 includes an optical structure is formed thereon. The optical structure has a wave-like structure of valleys 713 and ridges 714 that are alternatively arranged. Each of the valleys 713 has a curvature radius r of about 0.5 mm to about 1 mm. Each of the ridges 714 has a curvature radius R of about 0.5 mm to about 1 mm. A plan view of the ridges 714 is a semi-cylindrical like shape.

The light-diffusing member 710 has a first thickness T between the first face 711 and the ridges 714 and a second thickness t between the first face 711 and the valleys 713. To improve luminance and luminance uniformity of the light rays, the first and second thickness T and t are adjusted appropriately.

To improve luminance and luminance uniformity of the light rays emitted from the light source 720, the first thickness T may be about 1.15 to about 1.80 times thicker than the second thickness t. In particular, the first thickness T may be about 1.15 to about 1.35 times, about 1.35 to about 1.55 times thicker than the second thickness, about 1.55 to about 1.67 times thicker than the second thickness or about 1.67 to about 1.75 times thicker than the second thickness t. Preferably, the first thickness T is about 1.67 times thicker than the second thickness t.

The light source 720 may have a cylindrical like shape, a U like shape, a C like shape, etc. Also, the light source 720 may correspond to an internal CCFL or an external CCFL. The light source 720 faces the second face 712 of the light-diffusing member 710.

The display panel 800 faces the first face 711 of the light-diffusing member 710. The display panel 800 displays an image using light rays passing through the first face 711 of the light-diffusing member 710.

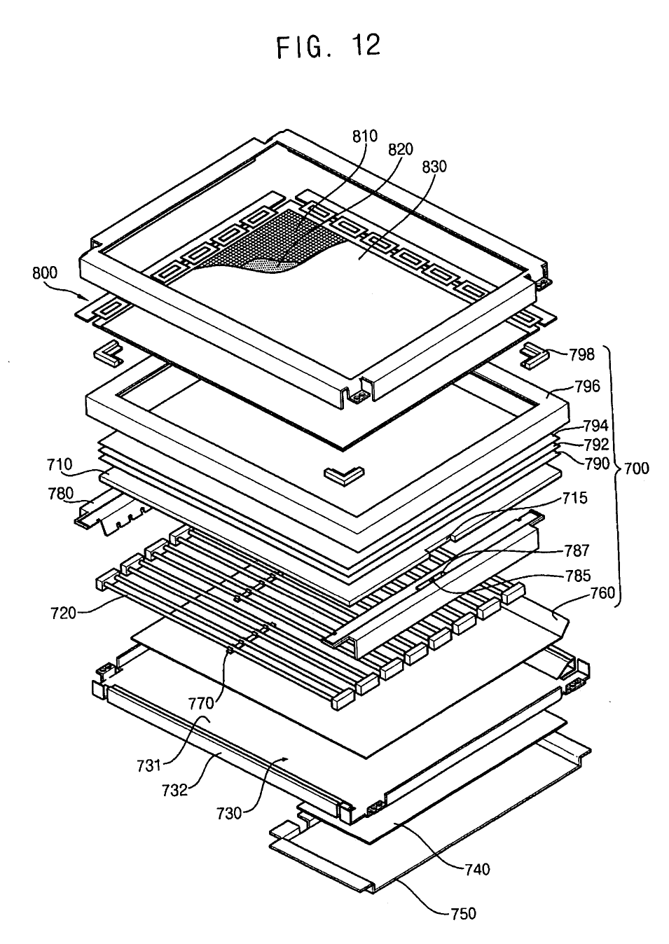

FIG. 12 is an exploded perspective view showing the display apparatus shown in FIG. 11.

Referring to FIG. 12, the backlight assembly 700 further includes a container 730 where the light-diffusing member 710 and the light source 720 are received.

The container 730 has a bottom face 731 and a sidewall 732 extending from an edge portion of the bottom face 731. The bottom face 731 and the sidewall 732 together define a receiving space where the light-diffusing member 710 and the light source 720 are received.

The backlight assembly 700 further may include an inverter 740 that provides a driving power for transmitting the light rays from the light source 720, to the light source 720. The inverter 740 may be installed below the bottom face 731 of the container 730.

A shield case 750 is combined with the bottom face 731 of the container 730 to cover the inverter 740 and remove harmful electromagnetic waves generated by the inverter 740.

A reflection plate 760 is arranged between the bottom face 731 of the container 730 and the light source 720. The reflection plate 760 may be arranged below the bottom face 731 of the container 730. The reflection plate 760 reflects light rays, to the light-diffusing member 710, which increases an amount of the light incident upon the second face 712 of the light-diffusing member 710.

The light source 720 is attached to the container 730 by a light source support 730. For example, the light source support 770 to which the light source 720 is attached is secured or attached to the container 730.

A fixing frame 780 covers opposite ends of the light source 720 and the light-diffusing member 710 is fixed or attached thereto. To prevent or substantially reduce the movement of the light-diffusing member 710 in the container 730, the light-diffusing member 710 may have a fixing slot 715 and the fixing frame 780 may have a fixing protrusion 785 that is inserted into the fixing slot 715. Alternatively, the fixing protrusion 785 may extend from the light-diffusing member 710 and the fixing frame 780 fixing slot 715 may be provided to the fixing frame 780.

An optical member may be arranged on the light-diffusing member 710. A fixing boss 787 may be arranged on the fixing protrusion 785 to be inserted into the optical member so that the optical member is attached to the fixing frame 780.

The optical member includes a diffusion sheet 790 arranged on the light-diffusing member 710. The diffusion sheet 790 diffuses again light rays passing through the first face 711 of the light-diffusing member 710. A prism sheet 792 may be arranged on the diffusion sheet 790. The prism sheet 792 increases front luminance of light rays passing through the diffusion sheet 790. Additionally, a reflective polarizing sheet 794 may be arranged on the prism sheet 792 to increase on amount of light passing through the prism sheet 792.

The backlight assembly 700 may further include a middle mold frame 796. The middle mold frame 796 may be combined with the container 730 to prevent or significantly reduce movement of the light-diffusion member 710. Panel-guiding members 798 may be arranged at edges of the middle mold frame 796 to guide positions of the edges of the display panel 800. The panel-guiding member 798 may include an elastic material.

The display panel 800 is arranged over the middle mold frame 796 and may be guided by the panel-guiding members 798. The display panel 800 may include a thin film transistor (TFT) substrate 810, and/or a color filter substrate 820, and/or an LC layer 830.

The TFT substrate 810 includes pixel electrodes arranged in a matrix like pattern, and TFTs electrically connected, e.g. coupled with each of the pixel electrodes to provide driving voltage to each of the pixel electrodes. The pixel electrodes may be formed of a material that includes indium tin oxide (ITO), indium zinc oxide (IZO), amorphous indium tin oxide (a-ITO), etc.

The color filter substrate 820 faces the TFT substrate 810. The color filter substrate 820 includes common electrodes facing each of the pixel electrodes. The common electrodes may be formed on an entire surface of the color filter substrate 820. The pixel electrodes may be formed of a material that includes indium tin oxide (ITO), indium zinc oxide (IZO), amorphous indium tin oxide (a-ITO), etc.

The LC layer 830 is arranged between the TFT substrate 810 and the color filter substrate 820. LC molecules in the LC layer 830 may be rearranged according to an intensity of an electric field generated in the area between the common electrodes and the pixel electrodes. The LC layer 830 changes transmissivity of the light rays passing through the light-diffusing member 710 in accordance with rearrangement of the LC molecules.

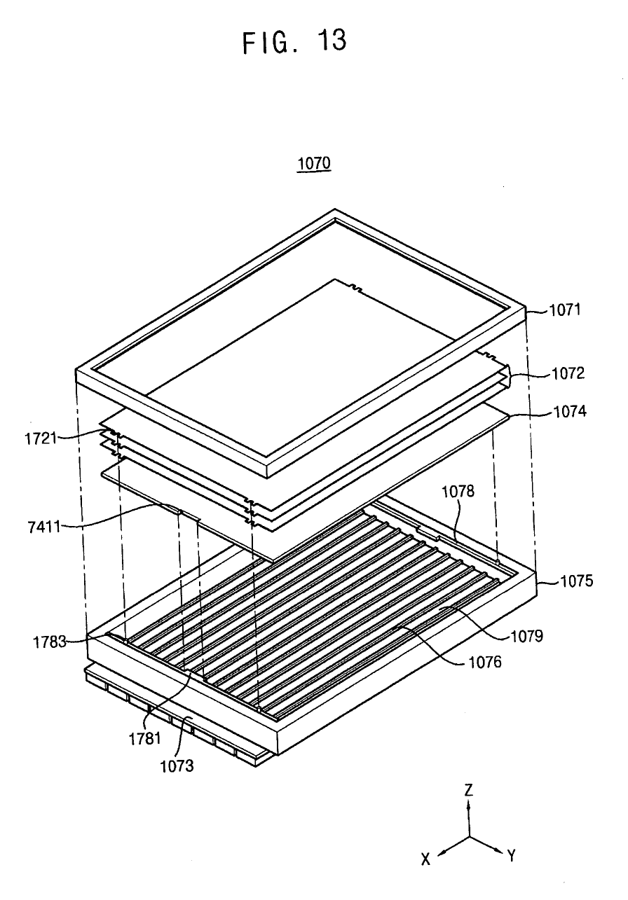

FIG. 13 is an exploded perspective view showing a backlight assembly according to an exemplary embodiment of the invention.

Referring to FIG. 13, a backlight assembly 1070 corresponds to a direct illumination type of backlight assembly. The backlight assembly 1070 includes a light source 1076 having a plurality of lamps that may be arranged in an X direction and are substantially in parallel with each other. The backlight assembly 1070 may be used in an LCD apparatus having a large size such as an LCD television. A backlight assembly having other structures different from that of the backlight assembly 1070 may be used in the invention.

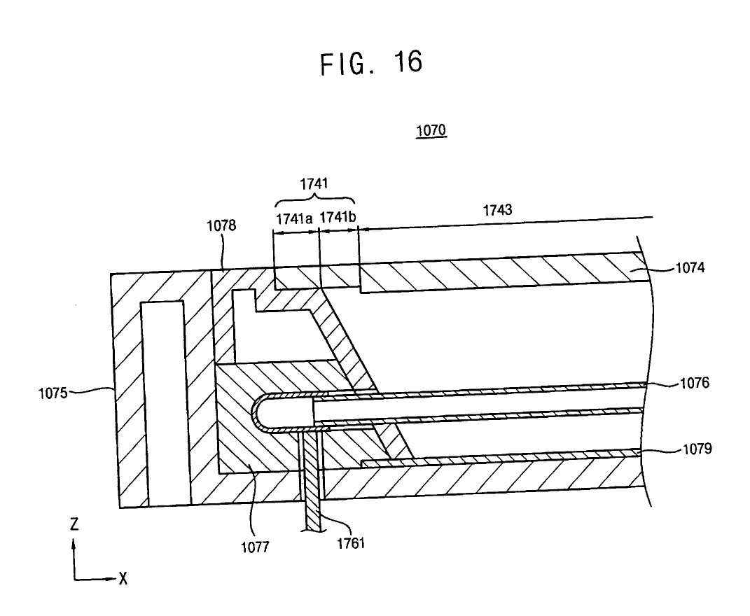

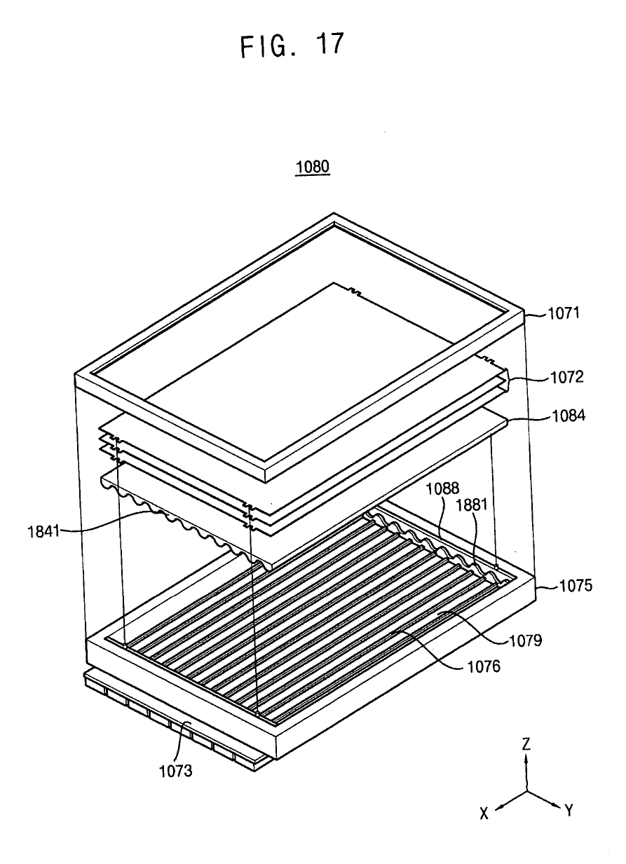

The backlight assembly 1070 includes an indented light-diffusing member 1074, the light source 1076, and a side frame 1078. Light rays emitted from the light source 1076 pass through the light-diffusing member 1074 so that the light rays diffuse. According to the embodiment shown in FIG. 13, the diffusing light rays exit in a Z direction, e.g., upward direction. The light source 1076, a light source holder 1077 (see FIG. 16), the side mold frame 1078, and a reflection sheet 1079 may be received in a bottom chassis 1075. A mold frame 1071 arranged over the light-diffusing member 1074 is attached with the bottom chassis 1075.

As shown in FIG. 13, the light source 1076 may include a plurality of lamps. However, the light source 1076 of the present invention is not restricted to lamps. Alternatively, the light source 1076 may include a light emitting diode (LED), a linear light source, etc.

The light source 1076 is secured to or attached with the bottom chassis 1075. The reflection sheet 1079 may be arranged on a bottom face of the bottom chassis 1075. The reflection sheet 1079 reflects the light rays emitted from the light source 1076. The light rays emitted from the light source 1076 diffuse when passing through the reflection sheet 1074. The light rays passing through the reflection sheet 1074 pass through an optical member 1072 to have increased luminance.

When the lamps are used as the light source 1076, the lamps may include a cold cathode fluorescent lamp (CCFL), an external electrode fluorescent lamp, etc. The light source holder 1077 may be used to support the light source 1076. The side frame 1078, e.g., a mold frame, may be used to cover the light source holder 1077.

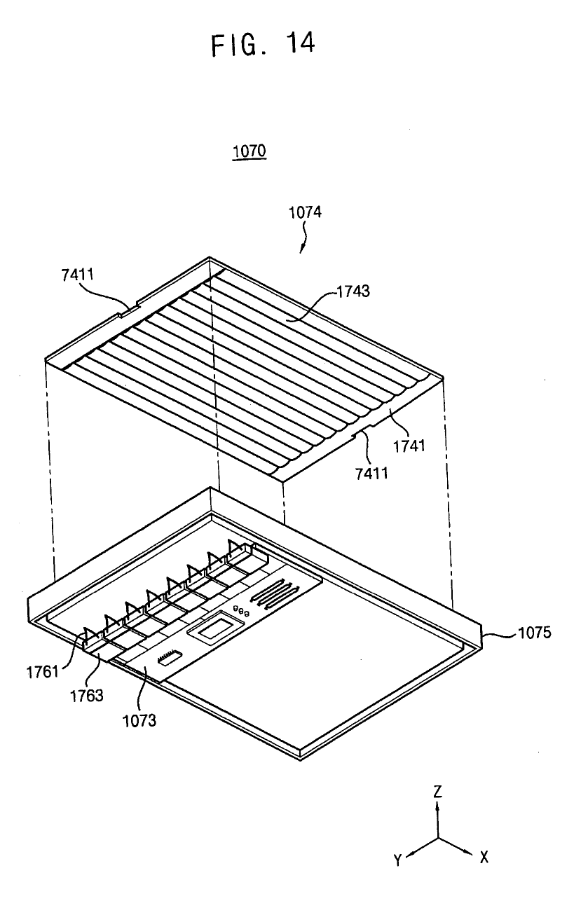

An inverter 1073 as a printed circuit board for providing power to the light source 1076 may be attached beneath the bottom face of the bottom chassis 1075. The inverter 1073 applies a voltage to the light source 1076 to drive the light source 1076. Thus, the light to source 1076 may be electrically connected, e.g., coupled with the inverter 1073 via a wire 1761 (see FIG. 14) and a socket 1763.

Fixing slots 7411 are arranged at side faces of the light-diffusing member 1074. Fixing protrusions 1781 arranged on the side frame 1078 are combined with the fixing slots 7411.

The light-diffusing member 1074 may be formed by an injection molding process using PMMA resin. The light-diffusing member 1074 may be partially cut to form the fixing slot 7411. It is understood that the invention is not limited to the above described and shown configuration, positioning and number of the fixing slots 7411, and that such may be changed by those skilled in the art.

The fixing slot 7411 may be arranged on the side mold frame 1078 and the fixing protrusion 1781 may be arranged on the light-diffusing member 1074.

Alternatively, the light-diffusing member 1074 may be attached with the bottom chassis 1075 instead of the side mold frame 1078. It is understood that the light-diffusing member 1074 may be secured using other securing elements.

Fixing grooves 1721 may be formed at both sides of the optical member 1072. Fixing bosses 1783 that are inserted into the fixing grooves 1721 may be formed on the side frame 1078. Alternatively, the fixing bosses 1783 may be formed on the bottom chassis 1075.

FIG. 14 is a partially exploded perspective bottom view showing the backlight assembly shown in FIG. 13. In particular, FIG. 14 shows a bottom face of the light-diffusing member 1074 of the backlight assembly.

Referring to FIG. 14, an indented structure 1743, e.g., a ridgelike structure, is arranged at the bottom face of the light-diffusing member 1074, which faces the light source 1075, e.g, in the X direction. That is, the indented structure 1743 includes ridges and valleys alternatively arrayed. The ridges of the indented structure 1743 prevent the formation of bright lines of the light source 1076, thereby improving luminance.

Edges of the light-diffusing member 1074 that face the side mold frame 1078 have a substantially level, e.g., flat, surface 1741. The substantially level surfaces 1741 of the light-diffusing member 1074 are arranged close to or in contact with the side mold frame 1078.

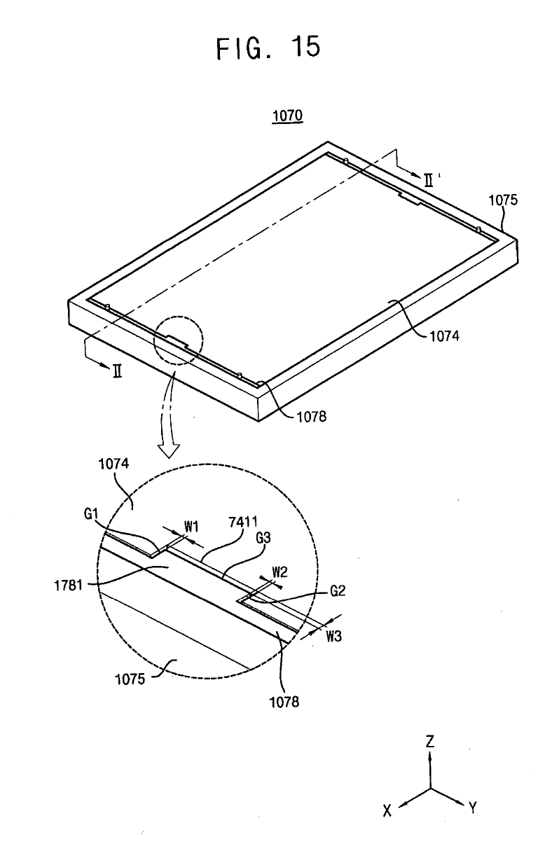

FIG. 15 is a perspective view showing the backlight assembly shown in FIG. 14.

Referring to FIG. 15, the substantially level surfaces 1741 of the light-diffusing member 1074 are attached with the side mold frame 1078. For example, each row of the light source 1076 is arranged in the X direction.

The fixing slot 7411 of the light-diffusing member 1074 is corresponds with the fixing protrusion 1781 of the side mold frame 1078. A first gap G1, a second gap G2, and a third gap G3 are formed between the fixing protrusion 1781 and the fixing slot 7411 to space them apart from each other. The first gap G1, the second gap G2, and the third gap G3 may be determined according to a thermal expansion of the light-diffusing member 1074. It is understood that the invention is not limited to three gaps.

In particular, the first gap G1, and the second gap G2 are arranged between side faces of the fixing slot 7411 and side faces of the fixing protrusion 1781. When the first gap G1 and the second gap G2 have widths W1 and W2 less than or equal to about 0.5 mm, respectively, a space in which the light-diffusing member 1074 is sufficiently combined with the side mold frame 1078. However, when the first gap G1 and the second gap G2 have widths W1 and W2 greater than about 0.5 mm, the light-diffusing member 1074 may move in the side mold frame 1078. Accordingly, the first gap G1 and the second gap G2 may have widths W1 and W2, respectively, of less than or equal to about 0.5 mm.

None of the widths W1 and W2 of the first gap G1 and the second gap G2 should be greater than about 0.1 mm.

When the backlight assembly 1070 is used in an upright position, the fixing protrusion 1781 of the side mold frame 1078 supports the fixing slot 7411 of the light-diffusing member 1074 to prevent deflection of the light-diffusing member. That is, when the backlight assembly 1070 is stood upright, any one of the side faces of the fixing protrusion 1781 contacts any one of the side faces of the fixing slot 7411. Thus, to efficiently prevent the deflection of the light-diffusing member 1074, any one of the widths W1 and W2 of the first gap G1 and the second gap G2 is preferably less than or equal to no more than about 0.1 mm.

The third gap G3 is formed between a front face of the fixing slot 7411 and a front face of the fixing protrusion 1781. When the third gap G3 has a width W3 of less than 1.6 mm, a space where the light-diffusing member 1074 is sufficiently combined with the side mold frame 1078 is not guaranteed such that the light-diffusing member 1074 may twist or deform due to the thermal expansion of the light-diffusing member 1074. Alternatively, when the third gap G3 has a width W3 greater than about 3.2 mm, a space where the light-diffusing member 1074 is combined with the side mold frame 1078 is too great such that the light-diffusing member 1074 may move in the side mold frame 1078. Thus, a width W3 is preferably about 1.6 mm to about 3.2 mm when considering the thermal expansion of the light-diffusing member 1074.

FIG. 16 is a cross sectional view taken along line II-II′ shown in FIG. 15.

Referring to FIG. 16, the light-diffusing member 1074 includes the indented structure 1743 and the substantially level surface 1741. The substantially level surface 1741 includes a first substantially level portion 1741a facing the side mold frame 1078 and a second substantially level portion 1741b arranged between the first substantially level portion 1741a and the indented structure 1743. That is, the second substantially level portion 1741b extends from the first substantially level portion 1741a to the indented structure 1743, e.g., along the X direction. The second substantially level portion 1741b extends the length of the flat surface 1741. Thus, although the backlight assembly 1070 may move, the indented structure 1743 does not move on the side mold frame 1078 so that the light-diffusing member 1074 is firmly attached with the side mold frame 1078.

When the second substantially level portion 1741b has a length that is greater than about 1.0 mm, a length of the indented structure 1743 is reduced. Thus, a length of the second substantially level portion 1741b is preferably less than or equal to about 1.0 mm.

According to the invention, the light-diffusing member 1074 increases diffusion efficiency of the light rays. Also, the light-diffusing member 1074 is sufficiently firmly attached such that the backlight assembly 1070 is more durable.

FIG. 17 is an exploded perspective view showing a backlight assembly according to an embodiment of the invention.

A backlight assembly 1080 includes elements that are substantially identical to the elements in FIG. 13, except for a light-diffusing member 1084 and a side mold frame 1088. Thus, same reference numerals refer to same elements and any further illustrations with respect to the same elements are omitted for purposes of convenience.

Referring to FIG. 17, an indented structure 1841, e.g., a ridge-like structure, may be arranged below an entire bottom face of the light-diffusing member 1084 that faces the light source 1076. For example, the indented structure 1841 may be arranged along a single direction, e.g., the X direction, below the entire bottom face of the light-diffusing member 1084. Thus, the side mold frame 1088 has an indented face 1881 combined with the indented structure 1841. The indented face 1881 may be formed by an injection molding process on the side mold frame 1088. The indented face 1881 and the indented structure 1841 may be combined to prevent bright lines of the light source 1076.

Alternatively, the indented structure 1841 may be combined with an indented face formed on the bottom chassis 1075. Also, the indented structure 1841 may be attached with bottom chassis 1075 using other securing elements.

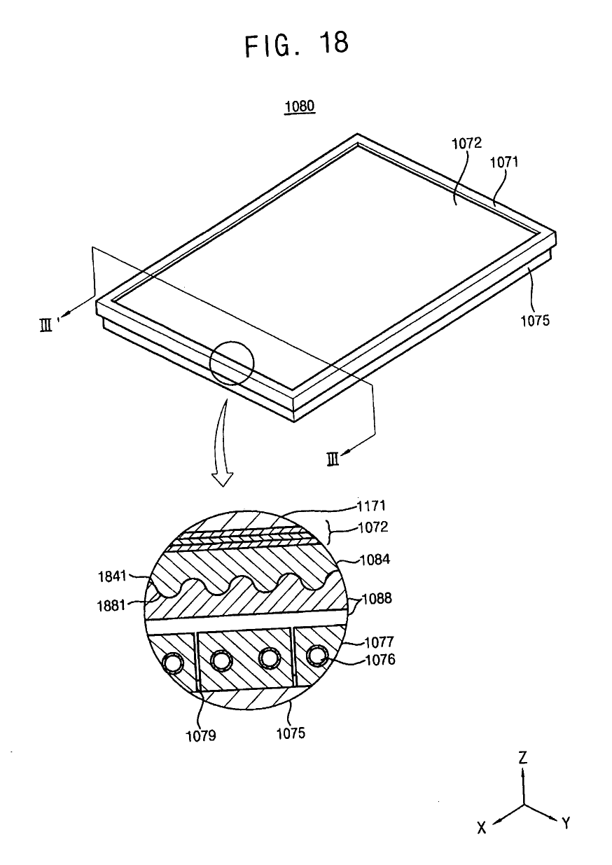

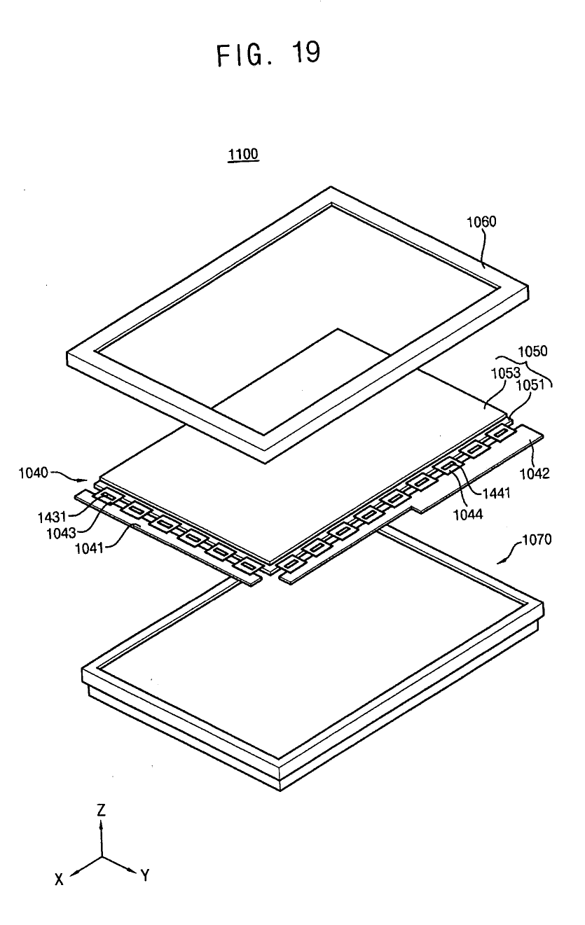

FIG. 18 is a perspective view illustrating the backlight assembly shown in FIG. 17. An enlarged circle is a cross sectional view taken along line III-III′ that extends along the side frame 1088 and the light source holder 1077.

Referring to FIG. 18, the ridges of the light-diffusing member 1084 are arranged above the light source 1076 to significantly reduce or prevent the bright lines of the light source 1076 from forming.

The indented structure 1841 of the light-diffusing member 1084 may be engaged with the indented surface 1881 of the side mold frame 1088 so that the light-diffusing member 1084 is attached with the side mold frame 1088 without there being any movement. As a result, the bright lines caused by mis-alignment between the light-diffusing member 1084 and the light source 1076 may be significantly reduced or prevented.

FIG. 19 is an exploded perspective view showing a display apparatus having the backlight assembly shown in FIG. 17 according to an embodiment of the invention.

Referring to FIG. 19, a display apparatus 1100 includes the backlight assembly 1070 and an LCD panel assembly 1040. Alternatively, other substantially level display panels may be used in the display apparatus 1100. A top chassis 1060 covers the LCD panel 1050 so that the LCD panel assembly 1040 may be assembled with the backlight assembly 1070, thereby completing the display apparatus 1100.

The LCD panel assembly 1040 includes an LCD panel 1050, driver-integrated circuit packages 1043 and 1044 providing driving signals to the LCD panel 1050, and printed circuit boards (PCB) 1041 and 1042. The driver-integrated circuit packages 1043 and 1044 may include a chip on film (COF), a tape carrier package (TCP), etc. The PCBs 1041 and 1042 are received in side spaces of the top chassis 1060.

The LCD panel 1050 includes a thin film transistor (TFT) substrate 1051 having a plurality of TFTs, a color filter substrate 1053 arranged over the TFT substrate 1051, and an LC layer arranged between the TFT substrate 1051 and the color filter substrate 1053. Additionally, a polarizing plate (not shown) that polarizes light rays passing through the LCD panel 1050 may be attached on the color filter substrate 1053 and beneath the TFT substrate 1051.

The TFT substrate 1051 includes a glass substrate on which the TFTs are arranged in a matrix like pattern. The TFT substrate 1051 includes source terminals electrically connected, e.g., coupled, with data lines and gate terminals electrically connected, e.g., coupled, with gate lines. Pixel electrodes including transparent ITO are arranged on drain terminals.

When electric signals are input into the gate terminals and the source terminals of the TFT substrate 1051 from the PCBs 1041 and 1042 through the gate lines and the data lines of the LCD panel 1050, the TFTs are turned on or turned off in accordance with the electric signals to output electric signals for forming pixels from the drain terminals.

Meanwhile, the color filter substrate 1053 is arranged facing the TFT substrate 1051. The color filter substrate 1053 is arranged over the TFT substrate 1051 and includes at least one color pixel member having a red pixel portion, a green pixel portion, and a blue pixel portion. When the light rays pass through the color pixel member, a color of the light may vary. The color pixel member may be formed in the color filter substrate 1053 by a thin film process. A front face of the color filter substrate 1053 is covered with a common electrode including a transparent conductive material such as ITO. When the thin film transistor is turned on, an electrical field is generated between the pixel electrodes and the common electrode. The electrical field may change an alignment of liquid crystal molecules included in the liquid crystal layer so that a light transparency of the liquid crystal layer may vary. Thus, the liquid crystal display panel 1050 display a desired image by varying transmissivity.

The first PCB 1041 and the second PCB 1042 are connected, e.g., coupled, with the first driven integrated circuit package 1043 and the second driver integrated circuit package 1044, respectively. The first PCB 1041 and the second PCB 1042 may receive external image signals and then provide the gate line and the data line with the drive signals. In order to operate the substantially level panel display device 1100, the first PCB 1041 and the second PCB 1042 generate a gate drive signal and a data drive signal, respectively. In addition, the first PCB 1041 and the second PCB 1042 generate a plurality of timing signals enabling the gate drive signal and the data drive signal to be applied to the gate line and the data line at a desired timing. The gate drive signal and the data drive signal may be applied to the gate line and the data line through the first driver integrated circuit package 1043 and the second driver integrated circuit package 1044, respectively. The first driver integrated circuit package 1043 and the second driver integrated circuit package 1044 include a first integrated chip 1431 and a second integrated chip 1441, respectively. A control board (not shown) is arranged below the backlight assembly 1070. The control board is connected, e.g., coupled, with the second printed circuit board 1042 to invert an analog data signal into a digital data signal. The control board then provides the liquid crystal display panel 1050 with the digital data signal.

The top chassis 1060 is arranged on the liquid crystal display panel assembly 1040. The top chassis 1060 may fold the first integrated circuit package 1043 and the second integrated circuit package 1044 toward a side face of the backlight assembly 1070. In addition, the top chassis 1060 may prevent or significantly preclude the liquid crystal display panel assembly 1040 from being separated from the backlight assembly 1070.

Although it is not specifically shown in FIG. 19, a front face case and a rear face case are arranged on the top chassis 1060 and below the bottom chassis 1075, respectively. The front face case and the rear face case may be combined to manufacture the substantially level panel display device 1100.

According to the invention, the backlight assembly 1070 having the light-diffusing member provides the liquid crystal display panel 1050 with the light having a relatively high luminance and a relatively high luminance uniformity. Thus, the substantially level panel display device 1100 may efficiently display an image.

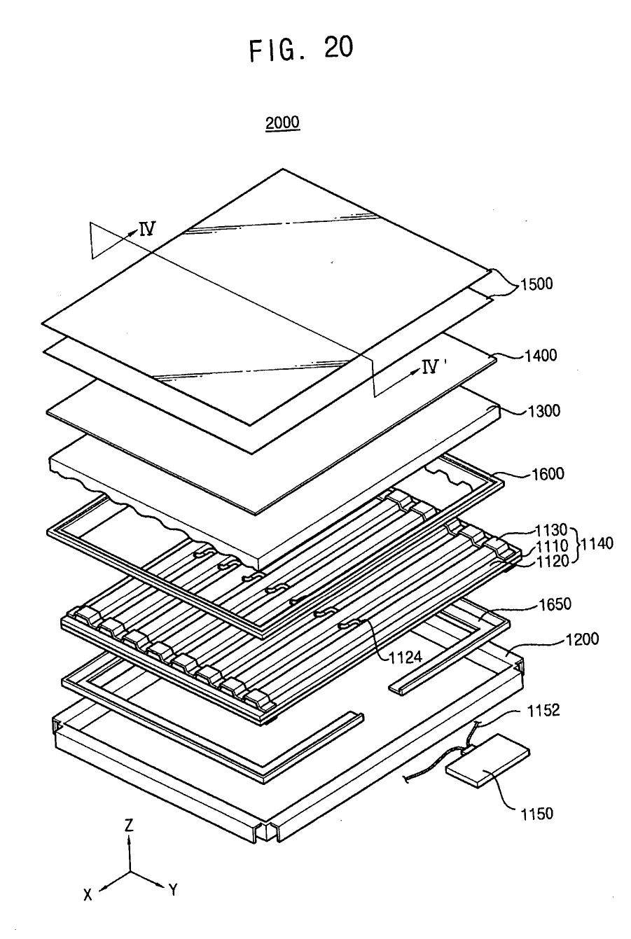

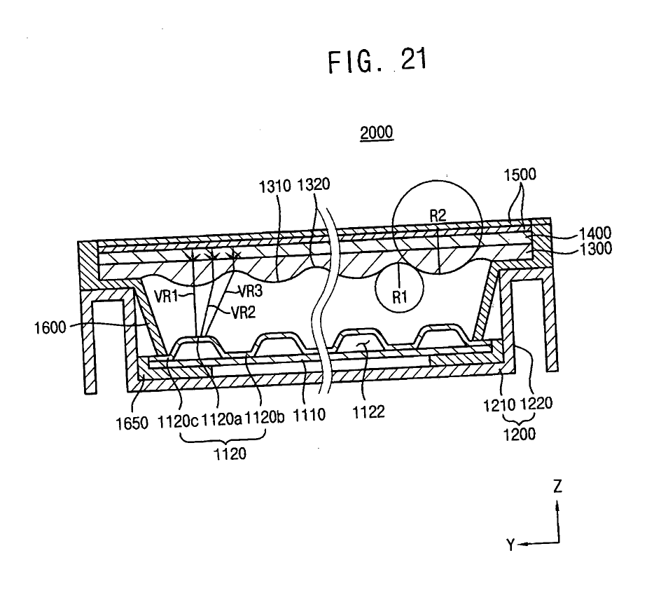

FIG. 20 is a perspective view illustrating a backlight assembly according to an embodiment of the invention. FIG. 21 is a cross-sectional view taken along a line IV-IV′ shown in FIG. 20.

Referring to FIG. 20 and FIG. 21, a backlight assembly 2000 includes a light source 1140, an inverter 1150, a receiving container 1200, a first optical member 1300, a second optical member 1400, an optical sheet member 1500, a first fixing member 1600 and a second fixing member 1650.

The light source 1140 may be a surface light source generating a planar light. The light source 1140 may include a body and an external electrode 1130. The body may have a plurality of discharge spaces 1122. The external electrode 1130 may cover end portions of the body. The body includes a first substrate 1110 and a second substrate 1120. The first substrate 1110 and the second substrate 1120 are combined to define the discharge spaces therebetween. The discharge space 1122 may have a width of about 14.15 mm. The width may be measured in a second direction. In addition, the discharge spaces 1122 are connected, e.g., coupled, with each other via connection pipes 1124 included in the second substrate 1120.

The first substrate 1110 may have a quadrilateral plate like shape having a predetermined thickness. The first substrate 1110 may be formed of a glass material. The first substrate 1110 may be formed of a material that is capable of blocking ultraviolet rays generated from the discharge space 1122.

The second substrate 1120 may be formed of a transparent material so that a visible ray generated from the discharge spaces 1122 may pass through the second substrate 1120. For example, the second substrate 1120 may be formed of a glass material. The second substrate 1120 may be formed of a material that is capable of blocking the ultraviolet rays generated from the discharge space 1122.

The second substrate 1120 includes discharge space portions 1120a, space separators 1120b, and sealing portions 1120c. The discharge space portion 1120a is spaced apart from the first substrate 1110 and defines the discharge space 1122 between the discharge space portion 1120a and the first substrate 1110. The space separating portion 1120b is arranged between the discharge space portions 1120a that are positioned adjacent to each other. In addition, the space separating portion 1120b may contact the first substrate 1110. The sealing portion 1120c is positioned at an edge portion of the second substrate 1120. The sealing portion 1120c contacts the first substrate 1110 to seal the discharge spaces 1122.

As illustrated in FIG. 21, the discharge space portions 1120a are arranged in a second direction. The space separator 1120b is connected between the discharge space portions 1120a that are adjacent to each other.

In addition, as illustrated in FIG. 21, a longitudinal section of the discharge space portion 1120a has a substantially arch like shape. However, many apparent variations of the longitudinal sections are possible. For example, the longitudinal section of the discharge space portion 1120 may have a semicircle like shape. According to another example, the longitudinal section of the discharge space portion 1120 may have a quadrilateral like shape. According to still another example, the longitudinal section of the discharge space portion 1120 may have a trapezoid like shape.

The second substrate 1120 may be formed using a molding process, such as an injection molding process and an extrusion molding process.

The connection pipe 1124 may be simultaneously formed with the second substrate 1120. That is, the connection pipe 1124 may be integrally formed with the second substrate 1120. Air and/or discharge gases are exhausted from or introduced to the discharge spaces 1122 through the connection pipe 1124.

The body includes a reflection layer (not shown), a first fluorescent layer (not shown) and a second fluorescent layer (not shown). The reflection layer may be arranged on an upper face of the first substrate 1110, the upper face of the first substrate 1110 facing a lower face of the second substrate 1120. The first fluorescent layer may be arranged on the reflection layer. The second fluorescent layer may be arranged below a lower face of the second substrate 1120, the lower face of the second substrate facing the reflection layer.

The reflection layer reflects visible rays generated from the first fluorescent layer and the second fluorescent layer toward the first optical member 1300 to reduce leakage of the visible rays through the first substrate 1110.

The first fluorescent layer and the second fluorescent layer may generate the visible rays by using the ultraviolet rays that are incident thereon. The ultraviolet rays may be generated by plasma discharges in the discharge spaces 1122.

The external electrodes 1130 are arranged on the first substrate 1110 and below the second substrate 1120 along a second direction. The external electrode 1130 corresponds to end portions of the discharge spaces 1122 so that the external electrode 1130 may at least partially overlap the discharge spaces 1122. The external electrode 1130 may be formed of a conductive material so that a discharge voltage supplied from the inverter 1150 to the external electrode 1130 may be efficiently transferred to the discharge spaces 1122 that are partially overlapped with the external electrode 1130.

The inverter 1150 may generate the discharge voltage for generating the plasma discharges. When a relatively low alternating current voltage is applied to the inverter 1150, the inverter may invert the relatively low alternating current voltage into a relatively high alternating current to be used as the discharge voltage. The inverter 1150 may be arranged below the receiving container 1200. The discharge voltage generated from the inverter 1150 may be transmitted to the external electrode 1130 of the light source 1140 via an electric wire 1152.

The receiving container 1200 includes a bottom portion 1210 and a side portion 1220. The side portion 1220 extends from an edge portion of the bottom portion 1210. The bottom portion 1210 and the side portion 1220 together define a receiving area where the light source 1140 is received. The side portion 1220 of the receiving container 1200 may have a substantially U-like shape. The receiving container 1200 may be formed of a relatively high strength metal.

The first optical member 1300 is arranged over the light source 1140. In detail, the first optical member 1300 may be spaced apart from the light source 1140 by a distance of about 13 mm in a third direction. A light generated from the light source 1140 is incident upon the first optical member 1300. The first optical member 1300 may disperse the light so that brightness uniformity is improved. The first optical member 1300 may be formed of a transparent material having a relatively high light transparency. Thus, preferably, the transparency of the first optical member 1300 is no less than about 90%.

An amount of the light incident upon the first optical member 1300 varies according to positions of the discharge spaces 1122 of the light sources 1140.

For example, a first portion of the optical member 1300 that is positioned over the space separating portion 1120 may be substantially thinner than a second portion of the optical member 1300 that is positioned over the discharge space 1122 of the light source 1140.

A lower face portion of the first optical member 1300 includes a plurality of ridges 1310 and a plurality of valleys 1320 that forms a wave like shape. The lower face portion may be formed by a molding process such as an extrusion molding process or an injection molding process. Specifically, the ridge 1310 of the first optical member 1300 corresponds to the discharge space 1122 of the light source 1140, and the ridge 1310 of the first optical member 1300 is positioned above, e.g., directly over, the discharge space portion 1120a having the arch-like shape.

A first thickness of the first portion of the first optical member 1300, the first portion being where the valleys 1320 are formed, is about 2.0 mm. A second thickness of the second portion of the first optical member 1300, the second portion being where the ridges 1310 are formed, is about 2.9 mm.

A first radius of curvature R1 of the first portion of the first optical member 1300 is about 14.12 mm. A second radius of curvature R2 of the second portion of the first optical member 1300 is also about 14.12 mm.

The light irregularly incident upon the lower face of the first optical member 1300 may be uniformly irradiated from an upper face of the first optical member 1300 because of the wave-like shape of the lower face of the first optical member 1300. Thus, the luminance uniformity may be improved. In addition, the wave shape of the first optical member 1300 may prevent the first optical member 1300 from being easily bent under conditions such as an external force, humidity and/or temperature, etc.

The plasma discharge is generated in the discharge space 1122 of the light source 1140. The plasma discharge may generate the ultraviolet rays enabling the first and second fluorescent layers to generate the visible rays. The visible rays include a first visible ray VR1, a second visible ray VR2 and a third visible ray VR3.

The first visible ray VR1 is irradiated from the discharge space 1122 in a third direction so that the first visible ray VR1 is directly incident upon the ridge 1310 of the first optical member 1300 in the third direction. The first visible ray VR1 may pass through the second portion of the optical member 1300 in the third direction without refraction. When the first visible ray VR1 passes through the second portion of the optical member 1300, there may be a significant decrease in the intensity of the first light because of the relative thickness of the second portion of the optical member 1300.

The second visible ray VR2 is irradiated from the discharge space 1122 in a direction horizontally inclined by a first angle with respect to the first visible ray VR1. The second visible ray VR2 may be incident upon a middle portion of the first optical member, the middle portion being arranged between the first portion and the second portion. When the second visible ray VR2 passes through the first optical member, the second visible ray VR2 may be refracted. In addition, when the second visible ray VR2 passes through the middle portion of the optical member 1300, a decrease in a rate of an intensity of the second light may be substantially less than that of the first light because the middle portion is substantially thinner than the second portion.

The third visible ray VR3 is irradiated from the discharge space 1122 in a direction horizontally inclined by a second angle with respect to the first visible ray VR1. Here, the second angle is substantially larger than the first angle. The third visible ray VR3 may be incident on the first portion of the first optical member 1300, the first portion where the valley 1320 is formed. When the third visible ray VR3 passes through the first optical member 1320, the third visible ray VR3 may be refracted. In addition, when the third visible ray VR3 passes through the first portion of the optical member 1300, a decreased rate of an intensity of the third light may be substantially smaller than that of the second light, because the first portion is substantially thinner than the middle portion.

As described above, the visible rays generated from the light source 1140 may be refracted in the first optical member 1300. In addition, when the visible rays pass through the first optical member 1300, intensities of the visible rays may vary. Thus, the brightness uniformity may be improved.

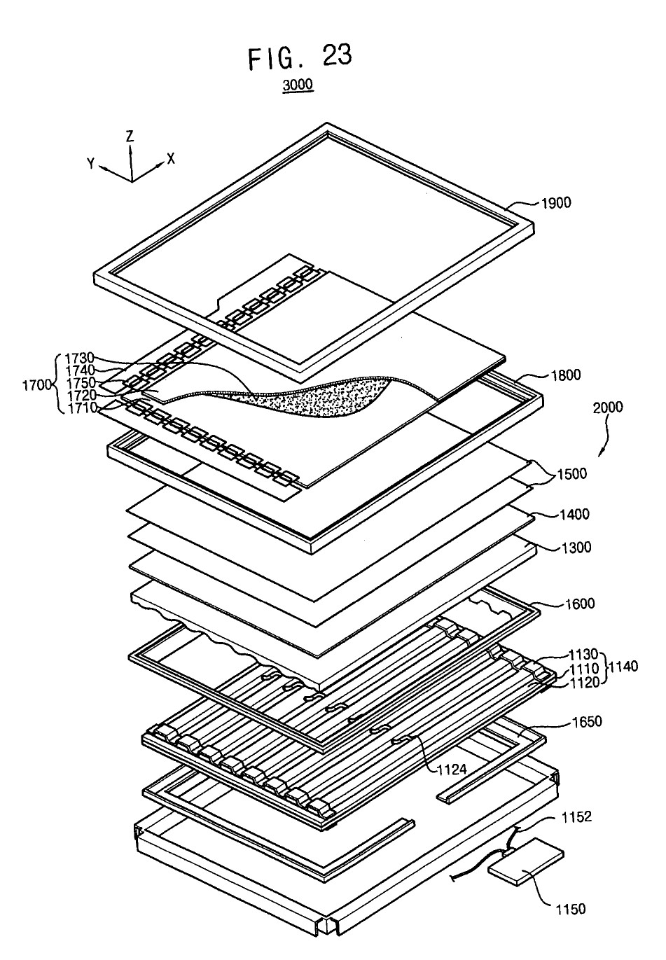

As illustrated in FIG. 23, the lower face of the first optical member 1300 has the wave shape. It is because a longitudinal section of the ridge 1310 has a semicircular cylindrical shape. However, many apparent variations of shapes of the longitudinal section are possible. As one example, the longitudinal section of the ridge 1310 has a triangle shape. As another example, the longitudinal section of the ridge 1310 has an arch shape. As another example, the longitudinal section of the ridge 1310 has a trapezoid shape.

The second optical member 1400 is positioned on the first optical member 1300. The second optical member 1400 may disperse a light irradiated from the first optical member 1300 to improve the brightness uniformity. The second optical member 1400 may be a plate like shape having a predetermined thickness may be formed of a transparent material. For example, the second optical member 1400 may be about 70% to about 80% transparent. The second optical member 1400 may include polymethylmethacrylate (PMMA) and may further include a dispersion member (not shown) to disperse the light.

The third optical member 1500 may be arranged on the second optical member 1400. The light irradiated from the second optical member 1400 may be incident upon the third optical sheet member 1500. The third optical sheet member 1500 may change a path of the light passing therethrough to improve the brightness. The third optical sheet member 1500 may include a concentration sheet that enables the light incident upon the third optical sheet member 1500 to be irradiated from the third optical sheet member 1500 in a third direction, which improves the brightness of the light. The third optical sheet member 1500 may further include a dispersion sheet to disperse the light incident thereon.

The first fixing member 1600 is arranged between the light source 1140 and the first optical member 1300. The first fixing member 1600 may be attached with the light source 1140. The first fixing member 1600 may further support the first optical member 1300, the second optical member 1400, and the third optical sheet member 1500. The first fixing member 1600 may be arranged on the light source 1140 and may be combined with side portions of the receiving container 1200. The first fixing member 1600 may partially cover an upper edge portion of the light source 1140. As shown in FIG. 20, the first fixing member 1600 may have a unibody frame-like shape. However, the first fixing member 1600 is not limited to such shapes. For example, the first fixing member 1600 may have two parts or four parts.

The second fixing member 1650 is arranged between the light source 1140 and the bottom portion 1210 of the receiving container 1200 to support the light source 1140. The second fixing member 1650 partially covers an edge of the light source 1140. The second fixing member 1650 is arranged between the light source 1140 and the bottom portion 1210 of the receiving container 1200 so that the light source 1140 and the receiving container 1200 may be electrically insulated from each other. The second fixing member 1650 may include an insulation material.

In addition, the second fixing member 1650 has sufficient elasticity so that the second fixing member 1650 may absorb an external impact. The second fixing member 1650 may include a first fixing portion and a second fixing portion that are spaced apart from each other. Each of the first fixing portion and the second fixing portion may be formed in an L-like shape.

However, the second fixing member 1650 may be variously shaped. For example, the second fixing member 1650 may be separated into four parts covering sidewalls of the light source 1140, or the second fixing member 1650 may be separated into four parts covering corners of the light source 1140. or the second fixing member 1650 may be formed as a single body.

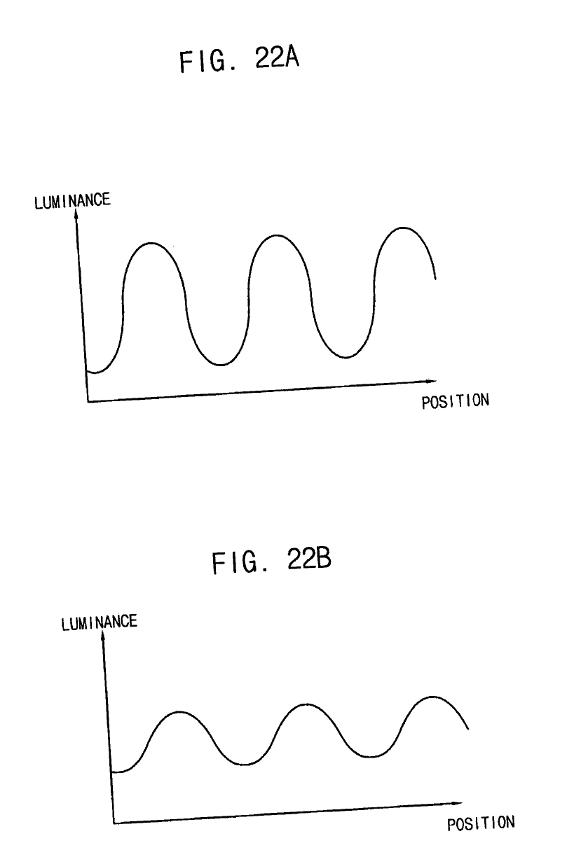

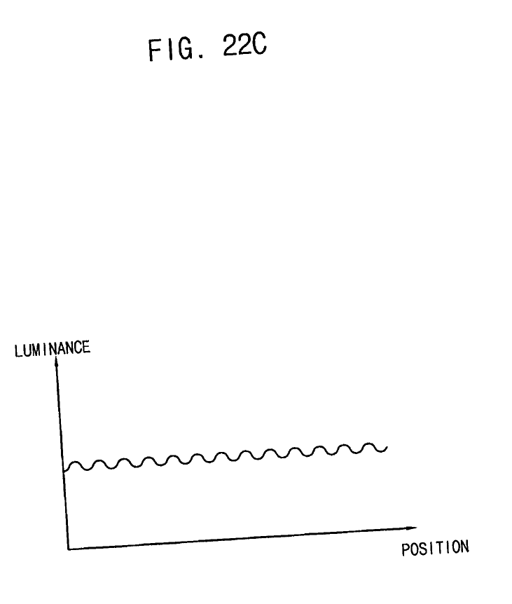

FIG. 22A, FIG. 22B, and FIG. 22C are graphs showing variations of luminance. In particular, in FIG. 22A, the graph shows a variation of luminance of the light irradiated from the light source in FIG. 21. In FIG. 22B, the graph shows a variation of luminance of the light irradiated from the first optical member shown in FIG. 21. In FIG. 22C, the graph shows a variation of luminance of the light irradiated from the second optical member shown in FIG. 21.

Referring to FIG. 21 and FIG. 22A, a luminance distribution of a light irradiated from the light source 1140 may vary with a substantially large amplitude in accordance with a position.

The luminance distribution of the light irradiated from the light source 1140 may vary with the substantially large first amplitude according to the positions of the discharge spaces 1122 of the light source 1140. That is, luminance of a light irradiated from the discharge space 1122 may be relatively high. In addition, luminance of the light irradiated between the discharge spaces 1122 that are adjacent to each other may be relatively low.

Referring to FIG. 21 and FIG. 22B, a luminance distribution of a light irradiated from the first optical member 1300 may vary with a second amplitude being substantially smaller than the first amplitude in accordance with the positions of the discharge spaces 1122 of the light source 1140.

The light irradiated from the light source 1140 may be incident upon the first optical member 1300 before passing through the first optical member 1300. The luminance distribution of the light irradiated from the first optical member 1300 may vary with the second amplitude being substantially smaller than the first amplitude according to the positions of the discharge spaces 1122 of the light source 1140.

Referring to FIG. 21 and FIG. 22C, a luminance distribution of a light irradiated from the second optical member 1400 may vary with a third amplitude being substantially smaller than the second amplitude.

The light irradiated from the light source 1140 may be incident upon the first optical member 1300 before passing through the first optical member 1300. The light that irradiates from the first optical member 1300 so that the light may be incident upon the second optical member 1400. The light then passes through the second optical member 1400. The luminance distribution of the light irradiated from the second optical member 1400 may vary with a third amplitude being substantially smaller than the second amplitude. As shown in FIG. 22C, the third amplitude is small and the brightness distribution of the light irradiated from the second optical member 1400 may be substantially irrelevant to the positions of the discharge spaces 1122 of the light source 1140.

According to the invention, the thickness of the first optical member 1300 is irregular, which improves the brightness of the light.

As shown in FIG. 21, the backlight assembly 2000 includes a surface light source having the discharge spaces 1122. Alternatively, the backlight assembly 2000 may have a cold cathode fluorescent lamp (CCFL) having a bar like shape instead of the face light source. Alternatively, the backlight assembly 2000 may have an external electrode fluorescent lamp (EEFL) instead of the face light source. Alternatively, the backlight assembly 2000 may include a light emitting diode (LED) instead of the face light source.

FIG. 23 is a perspective view showing a display device according to an embodiment of the invention.

A backlight assembly included in the display device is substantially identical to the backlight assembly shown in FIG. 21. Thus, the same reference numerals are used to refer to the same or like parts as those already illustrated in FIG. 21 and repetitive explanations thereof are omitted as necessary.

Referring to FIG. 23, a display device 3000 includes a backlight assembly 2000, a display panel 1700, a third fixing member 1800 and a fourth fixing member 1900.

The display panel 1700 is arranged on the backlight assembly 2000. The display panel 1700 may use a light irradiated from the backlight assembly 2000 to display an image. The display panel 1700 may include a thin film transistor substrate 1710, a color filter substrate 1720, a liquid crystal layer 1730, a printed circuit board 1740 and a flexible printed circuit board 1750.

The thin film transistor substrate 1710 includes pixel electrodes, thin film transistors TFT, and signal lines. The pixel electrodes are arranged in a matrix like shape. The thin film transistor provides a drive voltage to the pixel electrode. The signal lines are used for operating the thin film transistors.

The pixel electrode includes a transparent conductive material such as indium tin oxide film (ITO), indium zinc oxide film (IZO) and amorphous indium tin oxide film (a-ITO), etc. The pixel electrode may be formed by a patterning process such as a photolithography process.

The color filter substrate 1720 is arranged opposite to the thin film transistor substrate 1710. The color filter substrate 1720 includes a common electrode and color filters. The common electrode is arranged on a front face of the color filter substrate 1720. The color filters are arranged opposite to the pixel electrodes.

The color filters include a red color filter, a green color filter and a blue color filter. When a white light is incident upon the red color filter, a red light irradiates from the red color filter. When the white light is incident upon the green color filter, a green light irradiates from the green color filter. When the white light is incident upon the blue color filter, a blue light irradiates from the blue color filter.

The liquid crystal layer 1730 is arranged between the thin film transistor substrate 1710 and the color filter substrate 1720. the liquid crystal molecules in the liquid crystal layer 1730 may be arranged by applying an electrical field between the pixel electrode and the common electrode. Thus, a light transmissivity of the liquid crystal layer varies so that the display device may display an image.

The printed circuit board 1740 including a drive circuit unit inverts an external image signal into a drive signal to control the thin film transistor TFT. The printed circuit board 1740 includes a data printed circuit board and a gate printed circuit board. The flexible circuit board 1750 connected to the data printed circuit board is bent so that the data printed circuit board is arranged on either a side face or a rear face of the receiving container 1200. In addition, the flexible circuit board 1750 connected to the gate printed circuit board is bent so that the gate printed circuit board may be positioned on either the side face or the rear of the receiving container 1200. A signal wire may be formed in the thin film transistor substrate 1710 and the flexible printed circuit board 1750 instead of being formed in the gate printed circuit board.

The flexible printed circuit board 1750 may electrically connect, e.g., couple, the printed circuit board 1740 with the thin film transistor substrate 1710 so that the drive signal generated from the printed circuit board 1740 may be supplied to the thin film transistor substrate 1710. The flexible printed circuit board 1750 may be a tape carrier package (TCP) or a chip on film (COF).

The third fixing member 1800 is arranged between the third optical sheet member 1500 and the display panel 1700. The third fixing member 1800 may fix the first optical member 1300, the second optical member 1400, and the third optical sheet member 1500. The third fixing member may also support the display panel 1700. As shown in FIG. 23, the third fixing member 1800 may be formed as one body. However, many apparent variations of shapes of the third fixing member 1800 are possible. For example, the third fixing member 1800 may include two parts that are separated from each other, or may include four parts that are separated from each other.

The fourth fixing member 1900 encloses an edge of the display panel 1700 and is combined with a side portion of the receiving container 1200 so that the display panel 1700 may be fixed with an upper portion of the backlight assembly 2000.

The fourth fixing member 1900 prevents or significantly prevents the display panel 1700 having a relatively low brittleness from being damaged by external impacts and/or external vibrations. The fourth fixing member 1900 may also prevent or significantly prevent the display panel 1700 from being separated from the receiving container 1200.

According to the invention, a light-diffusing member has an irregular thickness so that luminance and luminance uniformity may be improved. In addition, a display device may display an image having a relatively high display quality.

A backlight assembly may not include a dual brightness improving film. As a result, a cost required for manufacturing the backlight assembly may be significantly reduced.

The foregoing is illustrative of the invention and is not to be construed as limiting thereof. It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A light-diffusing member, comprising:
a first face;
a second face arranged opposite to the first face; and
a light-diffusing portion including a valley being alternatively arranged with a ridge,
wherein a first thickness of the light-diffusing member between the ridge and the first face is about 1.15 to about 1.80 times greater than a second thickness of the light-diffusing member between the valley and the first face.

2. The light-diffusing member of claim 1, wherein the first thickness is about 1.15 to about 1.35 times greater than the second thickness.

3. The light-diffusing member of claim 1, wherein the first thickness is about 1.35 to about 1.55 times greater than the second thickness.

4. The light-diffusing member of claim 1, wherein the first thickness is about 1.55 to about 1.67 times greater than the second thickness.

5. The light-diffusing member of claim 1, wherein the first thickness is about 1.67 to about 1.75 times greater than the second thickness.

6. The light-diffusing member of claim 1, wherein the first thickness is about 1.67 times greater than the second thickness.

7. The light-diffusing member of claim 1, wherein the second thickness is about 1.5 mm to about 2.0 mm thick.

8. The light-diffusing member of claim 1, wherein the ridge is a semi-cylindrical like shape.

9. The light-diffusing member of claim 1, wherein the light-diffusing portion comprises polymethylmethacrylate (PMMA).

10. The light-diffusing member of claim 1, wherein at least one fixing slot is formed along an edge portion of the second face.

11. The light-diffusing member of claim 1, wherein at least one fixing protrusion is formed along an edge portion of the second face.

12. The light-diffusing member of claim 1, wherein the ridge comprises a curvature radius of about 0.5 mm to about 1.0 mm.

13. The light-diffusing member of claim 1, wherein the valley comprises a curvature radius of about 0.5 mm to about 1.0 mm.

14. The light-diffusing member of claim 1, further comprising a light-diffusing layer that includes a plurality of light-diffusing beads diffusing light rays passing through the first face, and a binder fixing the light-diffusing beads with the first face.

15. The light-diffusing member of claim 1, wherein the light-diffusing beads comprise polymethylmethacrylate (PMMA) and the binder comprises polyethylene terephthalate (PET).

16. A backlight assembly, comprising:
the light-diffusing member of claim 1; and
a light source facing the second face of the light-diffusing member to emit light rays, the light source being arranged to correspond with the ridge, wherein the light rays exit from the first face and are incident upon the second face.

17. The backlight assembly of claim 16, wherein the first thickness is about 1.15 to about 1.35 times greater than the second thickness.

18. The backlight assembly of claim 16, wherein the first thickness is about 1.35 to about 1.55 times greater than the second thickness.

19. The backlight assembly of claim 16, wherein the first thickness is about 1.55 to about 1.67 times greater than the second thickness.

20. The backlight assembly of claim 16, wherein the first thickness is about 1.67 to about 1.75 times greater than the second thickness.

21. The backlight assembly of claim 16, wherein the first thickness is about 1.67 times greater than the second thickness.

22. The backlight assembly of claim 16, wherein the second thickness is about 1.5 mm to about 2.0 mm thick.

23. The backlight assembly of claim 16, wherein the ridge is a semi-cylindrical like shape.

24. The backlight assembly of claim 16, wherein the light-diffusing portion comprises polymethylmethacrylate (PMMA).

25. The backlight assembly of claim 16, wherein the light source comprises a cold cathode fluorescent lamp (CCFL) having a tubular-like shape.

26. The backlight assembly of claim 25, wherein the CCFL is arranged substantially in parallel with the light-diffusing portion.

27. The backlight assembly of claim 16, wherein a diffusion sheet is arranged on the first face.

28. The backlight assembly of claim 16, wherein a light-diffusing layer is arranged on the first face, the light-diffusing layer including a plurality of light-diffusing beads diffusing light rays passing through the first face, and a binder fixing the light-diffusing beads with the first face.

29. The backlight assembly of claim 28, wherein the light-diffusing beads comprise polymethylmethacrylate (PMMA) and the binder comprises polyethylene terephthalate (PET).

30. The backlight assembly of claim 16, further comprising:
a container receiving the light-diffusing member and the light source;
wherein the container comprises a fixing frame that fixes the light-diffusing member with the container.

31. The backlight assembly of claim 30, wherein a fixing protrusion is provided on the fixing frame, and a fixing slot corresponding with the fixing protrusion is provided at the light-diffusing member.

32. The backlight assembly of claim 30, wherein a fixing protrusion is provided on the light-diffusing member, and a fixing slot corresponding with the fixing protrusion is provided at the fixing frame.

33. A display apparatus comprising:
the backlight assembly of claim 16; and
a display panel displaying an image using a light that passes through the first face.

34. The display apparatus of claim 33, further comprising:
a container receiving the light-diffusing member and the light source,
wherein the container comprises a fixing frame that fixes the light-diffusing member with the container.

35. The display apparatus of claim 34, wherein the fixing frame comprises a fixing portion corresponding with the light-diffusing member.

36. The display apparatus of claim 35, wherein the fixing portion comprises a slot.

37. The display apparatus of claim 35, wherein the fixing portion comprises a protrusion.

38. The display apparatus of claim 35, wherein a fixing boss is provided on the fixing frame, and a fixing groove where the fixing boss is inserted is provided at the light-diffusing member.

39. A backlight assembly, comprising:
a light source;
a light-diffusing member diffusing a light emitted from the light source, the light-diffusing member including a face that faces the light source and has an indented structure extending along a lengthwise direction of the light source, and a substantially level portion; and
a fixing member supporting the substantially level portion of the light-diffusing member with the light diffusing member.

40. The backlight assembly of claim 39, wherein a fixing slot corresponding to the fixing member is arranged at a side face of the light-diffusing member.

41. The backlight assembly of claim 40, wherein the fixing member comprises a protrusion corresponding with the fixing slot wherein there is, a gap between the fixing protrusion and the fixing slot.

42. The backlight assembly of claim 41, wherein a width of the gap is less than or equal to about 0.5 mm along a width direction of the light source.

43. The backlight assembly of claim 42, wherein the gap comprises a first gap and second gap positioned between side faces of the fixing protrusion and the fixing slot wherein the width of the first gap and the second gap is greater than or equal to about 0.1 mm along the width direction of the light source.

44. The backlight assembly of claim 43, wherein the gap has a width along the lengthwise direction of the light source that is about 1.6 mm to about 3.2 mm.

45. The backlight assembly of claim 39, wherein the face of the light-diffusing member further comprises a second substantially level face formed between the first substantially level face and the indented structure.

46. The backlight assembly of claim 45, wherein the second substantially level portion has a length along a lengthwise direction of the light source that is less than or equal to about 1.0 mm.

47. The backlight assembly of claim 39, wherein the fixing member comprises an indented portion that corresponds with the indented structure of the light-diffusing member.

48. The backlight assembly of claim 47, further comprising:
a light source holder supporting both ends of the light source, the light source holder being covered by the fixing member.

49. The backlight assembly of claim 48, wherein the light source is a lamp.

50. A flat display apparatus, comprising:
the backlight assembly of claim 39; and
a substantially level display panel displaying an images,
wherein the backlight assembly provides a light to the substantially level display panel.

51. The flat display apparatus of claim 50, wherein the substantially level display panel comprises a liquid crystal display panel.

52. A backlight assembly, comprising:
a light source generating a first light having a first luminance and a second light having a second luminance that is different from the first luminance; and
a first optical member arranged over the light source to provide the first light and the second light with uniformity, the first optical member including a first portion having a first thickness and a second portion having a second thickness that is different from the first thickness.

53. The backlight assembly of claim 52, wherein the first luminance is less than the second luminance, and wherein the first thickness of the first optical member corresponding to the first luminance is less than the second thickness corresponding to the second luminance.

54. The backlight assembly of claim 52, wherein the first optical member has a wave-like structure including a plurality of alternatively arranged ridges and valleys.

55. The backlight assembly of claim 54, wherein the wave-like structure is formed by an extrusion molding process.

56. The backlight assembly of claim 54, wherein the wave-like structure is formed by an injection molding process.

57. The backlight assembly of claim 54, wherein the wave-like structure is formed at a lower face of the first optical member that faces the light source.

58. The backlight assembly of claim 52, wherein the light source includes a plurality of discharge space portions that form a plurality of discharge spaces.

59. The backlight assembly of claim 58, wherein the first optical member has a wave-like structure including a plurality of alternatively arranged ridges and valleys corresponding with the discharge space portions.

60. The backlight assembly of claim 57, wherein each of the discharge space portions has an arch like shape.

61. The backlight assembly of claim 52, further comprising:
a second optical member being positioned above the first optical member, the second optical member diffusing a light irradiated from the first optical member.

62. A display apparatus, comprising:
the backlight assembly of claim 52; and
a display panel arranged above the backlight assembly to display an image using a light emitted from the backlight assembly.
